(19) United States
(12) Patent Application Publication
(10) Pub. No.: US 2015/0019058 A1
(43) Pub. Date: Jan. 15, 2015

(54) REGENERATIVE BRAKING REGULATION IN AUTOMOTIVE VEHICLES

(71) Applicant: Stephan P. GEORGIEV, St-Hubert (CA)

(72) Inventor: Stephan P. GEORGIEV, St-Hubert (CA)

(21) Appl. No.: 14/328,469

(22) Filed: Jul. 10, 2014

Related U.S. Application Data
(60) Provisional application No. 61/845,701, filed on Jul. 12, 2013.
(60) Provisional application No. 61/866,257, filed on Aug. 15, 2013.
(60) Provisional application No. 62/019,997, filed on Jul. 2, 2014.

(51) Int. Cl. B60L 7/18; B60L 7/10

(52) U.S. Cl. CPC B60L 7/18; B60L 7/10
USPC 701/22

(57) ABSTRACT

The invention relates to a self-learning regenerative control system that adapts to the user's driving style. The system receives as input a signal that is indicative of the friction brake usage and adapts the degree of regenerative braking accordingly. When the friction brake usage is high, the system will make the regenerative braking more aggressive such that when the user lifts-off the foot from the accelerator pedal, the degree of regenerative braking will be higher, thus reducing the need to use friction brakes. The system continuously adapts the regenerative braking intensity based on driving style, road conditions, etc.

### FIELD OF THE INVENTION

The present invention relates to regenerative braking control in automotive vehicles. More specifically, it relates to techniques, systems and devices to perform regenerative braking control based on different driving conditions.

### BACKGROUND OF THE INVENTION

Electric or hybrid vehicles use regeneration to capture the kinetic energy of the vehicle that would otherwise be wasted. This is useful from an efficiency perspective allowing to convert the kinetic energy into electric energy that can be used later for propulsion. In addition, regeneration slows the vehicle down which can be useful in circumstances where the speed needs to be reduced.

Regeneration is performed by establishing a driving relationship between one or more wheels of the vehicle and an electrical generator. In most cases, the electrical generator is the electric motor that drives the vehicle when in propulsion mode. Power electronics manage the electric motor/generator such that when it is driven as the vehicle coasts, it generates electricity which is used to recharge the batteries of the vehicle.

In existing hybrid or purely electric vehicles, the amount of regeneration that can be produced is typically fixed by design. In some instances, driver controls are provided allowing to select a degree of regeneration along several possible degrees of regeneration. In this fashion, the driver can adapt the degree of regeneration to current conditions and his/her driving style.

However, there exists a need in the industry to provide a more refined regeneration control in automotive vehicles. The present invention aims to alleviate this difficulty by providing a more sophisticated regeneration control techniques that rely on different inputs to tailor the degree of regeneration to current driving conditions and driver preferences.

### SUMMARY OF THE INVENTION

In a first broad aspect, the invention provides a method for controlling the degree of regeneration in an automotive vehicle that has an electric drive motor which is powered by a battery. The electric drive motor can behave as a generator when driven by one or more of the driving wheels. The method includes computing a degree of regeneration by using as a factor the rate of release of the accelerator pedal.

When the accelerator pedal is released very quickly by the driver, which may indicate the need to reduce the vehicle speed very quickly, such as during an emergency situation when the driver needs to avoid a collision, the degree of regeneration is increased than if the accelerator pedal is released more gently. In this fashion, the higher regeneration, provides the benefit of reducing the vehicle speed in an appreciable manner even before the driver has started applied the brakes.

In a specific and non-limiting example of implementation, the method observes the output of the accelerator position sensor, processes the output signal with software and computes a degree of regeneration to be applied. The processing of the accelerator position sensor signal involves a computation of a rate of variation of the signal to determine the rate at which the accelerator pedal is being released. A high rate of release is an indication that the speed of the vehicle needs to be reduced rapidly.

When the rate of release of the accelerator pedal is determined to be higher than a threshold, the regeneration effect can be invoked even before the accelerator pedal has returned to its rest position. The rest position is the position at which the accelerator pedal remains when no foot pressure is being applied to it.

In another possible example implementation, an additional factor can be taken into account in determining the degree of regeneration to be applied to the vehicle. This additional factor is the speed of the vehicle when the accelerator pedal is released fully or partially. When the vehicle travels at speeds which are relatively high, for example speeds near the speed limit on highways, a sudden release of the accelerator pedal is an uncommon maneuver unless the driver's intent is to quickly reduce the vehicle speed to avoid a collision. In such instance, the vehicle speed and the rate of release of the accelerator pedal jointly are better indicators of the driver's intent than the rate of release of the accelerator pedal along.

In a second broad aspect, the invention provides a method for controlling the degree of regeneration in an automotive vehicle that has an electric motor which is powered by a battery. The electric motor behaves as a generator when it is caused to rotate by one or more of the driving wheels to which it is connected. En electronic control module regulates the amount of electric power that the drive motor/generator supplies when in drive mode based at least in part on the position of a foot operated accelerator pedal. The accelerator pedal is moveable between a rest position, which is the position it acquires when no foot pressure is applied to it and a fully depressed position. An accelerator position sensor, outputs a signal that is indicative of a degree to which the accelerator of the vehicle is depressed by the driver's foot between the rest position and the fully depressed position. The method includes detecting a release of the accelerator pedal by observing the accelerator position sensor signal and controlling the electric motor/generator such to provide regeneration effect before the accelerator pedal has returned to its rest position.

In a third broad aspect, the invention provides a method for controlling a degree of regeneration in an automotive vehicle on the basis of output of a proximity sensor. A proximity sensor outputs a signal conveying proximity information indicating how far the vehicle is from another object. The other object can be a moving object or another vehicle or a stationary object. The regeneration effect which slows down the vehicle is invoked by releasing the accelerator pedal. The degree of regeneration is computed on the basis if the proximity sensor output. The degree of regeneration increases with an indication by the proximity sensor output that the distance separating the vehicle from the other object is below a certain threshold. In other words, when the distance is below the threshold the degree of regeneration is higher than if the distance is above the threshold. Another possible control strategy is the progressively increase the degree of regeneration when the proximity sensor output indicates that the distance continuously decreases, indicating that the automotive vehicle gets closer to the object.

In a fourth broad aspect, the invention provides a method for performing cruise control in a vehicle having one or more wheels in a driving relationship with an electric generator. The method includes making a determination between a set vehicle speed and an actual vehicle speed and if the actual vehicle exceed the set vehicle speed. If the actual speed exceeds the set speed, the method includes controlling the electric generator to provide regenerative braking to reduce an error between the set speed and the actual speed, the controlling being effected without application of the vehicle brakes.

In a fifth broad aspect, the invention provides a method for controlling regenerative braking in a motor vehicle based on an input that conveys speed limit information. The method includes determining a speed limit on a road on which the vehicle travels and an actual speed of the vehicle. If the actual speed exceeds the speed limit when the accelerator pedal of the vehicle is released, the method includes performing a speed reduction procedure by invoking regenerative braking of a magnitude that is dependent on the difference between the actual speed and the speed limit. In a specific and non-limiting example of implementation, the speed reduction procedure is carried out without application of the vehicle brakes.

With this method, when the vehicle travels substantially above the speed limit, releasing the accelerator pedal will invoke a high regenerative braking to bring the speed down rapidly and thus bring the vehicle in compliance with traffic regulation. When the speed is near or at the speed limit the regenerative braking is reduced to allow the vehicle to coast at a lawful speeds.

In a sixth broad aspect, the invention provides a method for controlling regenerative braking in a motor vehicle based on an input that conveys steering angle information. The method includes determining a steering angle of the vehicle when the accelerator pedal of the vehicle is released, and performing a speed reduction procedure by invoking regenerative braking of a magnitude that is dependent on the steering angle. In a specific and non-limiting example of implementation, the speed reduction procedure is carried out without application of the vehicle brakes.

A high steering angle input, especially when the speed of the vehicle is high, such as at highway speeds, is an indicator of an emergency situation when the vehicle is rapidly changing course to avoid an obstacle. During such en emergency situation it is preferable to reduce the vehicle speed as quickly as possible to provide additional reaction time to the driver and thus safely bring the vehicle to stop or avoid an obstacle on the road. By increasing the regenerative braking when the steering angle is high, a significant velocity reduction may be achieved automatically prior the application of the vehicle brakes, if the vehicle brakes need eventually to be applied to bring the vehicle to a stop.

### BRIEF DESCRIPTION OF THE DRAWINGS

FIG. 1 is a high level diagram illustrating the various components of a power train of an electric vehicle that uses a transmission for coupling the electric motor to the vehicle wheels;

FIG. 2 is a variant of the power train shown in FIG. 1, in which the electric motor drives directly the wheels of the vehicle;

FIG. 3 is yet another variant of the power train which is a four wheel drive arrangement where the four wheels of the vehicle are driven by electric motors;

FIG. 4 is yet another variant of the power train in which electric motors are integrated in the wheels of the vehicle;

FIG. 5 is a block diagram illustrating components of a control module used to regulate regenerative braking in the various power train options illustrated in FIGS. 1-4;

FIG. 6 is a flowchart of a process implemented by the control module illustrated in FIG. 5 for regulating the regenerative braking of the vehicle based on the rate of release of the accelerator pedal;

FIG. 7 is a flowchart of a process implemented by the control module illustrated in FIG. 5 for regulating the regenerative braking of the vehicle based on proximity information received from a proximity sensor on the vehicle;

FIG. 8 is a flowchart of a process implemented by the control module illustrated in FIG. 5 for regulating the regenerative braking to adjust the speed of the vehicle according to a set speed;

FIG. 9 is a flowchart of a process implemented by the control module illustrated in FIG. 5 for regulating the regenerative braking according to speed limit information;

FIG. 10 is a flowchart of a process implemented by the control module illustrated in FIG. 5 for regulating the regenerative braking according to terrain information;

FIG. 11 is a flowchart of a process implemented by the control module illustrated in FIG. 5 for regulating the regenerative braking according to road-type information;

FIG. 12 is a flowchart of a process implemented by the control module illustrated in FIG. 5 for regulating the regenerative braking to enhance the vehicle stability;

FIG. 13 is a graph illustrating an example of a relationship between the degree of regenerative braking and the rate of release of the accelerator pedal;

FIG. 14 is a graph illustrating an example of a relationship between the degree of regenerative braking and the rate of release of the accelerator pedal, according to a variant;

FIG. 15 is a flowchart of a process for adapting the degree of regenerative braking depending on usage of the friction brakes of the vehicle;

FIG. 16 is a graph which illustrates the relationship between friction brake usage depending on driver behavior;

FIG. 17 is a flowchart of a process for adapting the degree of regenerative braking depending on compensation by the driver for excessive regenerative braking;

FIG. 18 is a graph illustrating the vehicle speed versus time, showing the evolution of the vehicle speed when the vehicle is being brought to a stop, when the driver compensates for excessive regenerative braking;

FIG. 19 is a graph similar to FIG. 19 but showing a scenario where the degree of regenerative braking is such that no compensation by the driver is required;

FIG. 20 is a block diagram of a brake controller;

FIG. 21 is a graph illustrating a map of the regenerative braking based on proximity and speed;

FIG. 22 is a graph which illustrates the braking operation of the vehicle that blends regenerative braking and friction braking.

FIG. 23 is a graph illustrating a first relationship between proximity, speed and regenerative braking;

FIG. 24 is a graph illustrating a second relationship between proximity, speed and regenerative braking;

FIG. 25 illustrates a vehicle traveling on a road with a variable grade;

FIG. 26 is a flowchart illustrating the steps of a process for determining the regenerative braking magnitude by referencing a database;

FIG. 27 illustrates conceptually the structure of a database correlating different roads with position information;

FIG. 28 is a table mapping position information to regenerative braking intensities;

FIG. 29 is a flowchart of a process for independently controlling the regenerative braking acting on the front wheels of the vehicle and the rear wheels of the vehicle;

FIG. 30 is a graph showing how the magnitude of the regenerative braking varies with the speed of rotation of the electric motor/generator;

FIG. 31 is a flowchart of a process for managing regenerative braking when wheel slip is detected;

FIG. 32 is a flowchart of a process for providing stability control;

FIG. 33 is a flowchart of a process for controlling the regenerative braking magnitude based on speed limit information;

FIGS. 34 and 35 is a graph illustrating possible regenerative braking control strategies according to the process of FIG. 33.

FIG. 36 illustrates schematically a battery used for propulsion and a buffer reserved for use when an auxiliary power source is relied upon to propel the vehicle;

FIG. 37 is a Graphical User Interface (GUI) showing a message that allows the driver to authorize use of the buffer for EV mode operation only;

FIGS. 38 and 39 are flowcharts that illustrate processes to determine if the buffer of FIG. 36 can be relied upon for EV mode use only.

### DETAILED DESCRIPTION

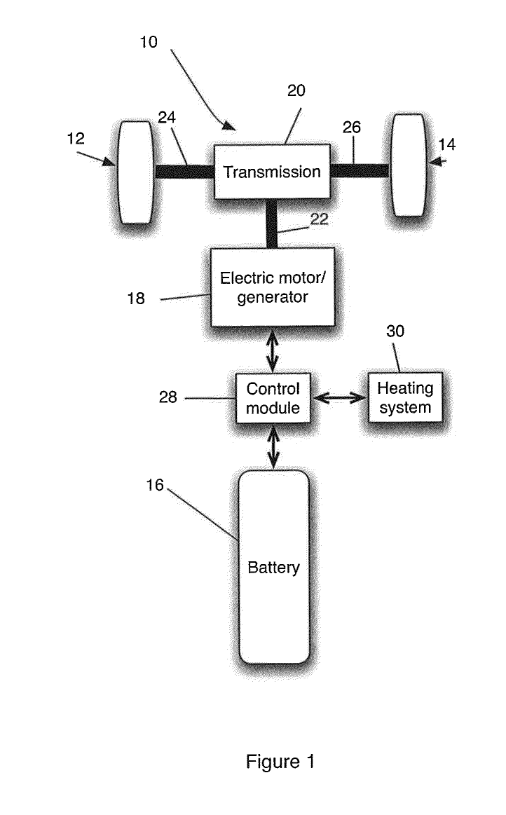

FIG. 1 illustrates the layout of the various components of an electric vehicle 10. The vehicle 10 includes electric motor propulsion. The electric motor propulsion can be the sole mode of propulsion of the vehicle 10 or it can be assisted with another mode of propulsion such as an engine using a petroleum based fuel. For simplicity, the engine using petroleum based fuel is not shown in the drawings.

The vehicle 10 has two drive wheels 12 and 14 which could be the front wheels of the vehicle or the rear wheels thereof. Although not shown in the drawings, it is to be understood that the vehicle 10 would also have two other wheels which are not driven.

A battery 16 provides electrical energy storage. The size of the battery can vary depending on the intended application, in particular the desired range of the vehicle 10. As a practical example, the battery 16 can have a capacity ranging between 10 kW/h to 100 kW/h. The chemistry of the battery 16 is not critical to the invention. For example, the battery 16 may be based on LiFePO₄ or any other suitable compound.

An electric motor/generator 18 propels the vehicle. The electric motor/generator includes at least one electric motor used for propulsion. The electric motor can use permanent magnets or it can be an induction motor. In one possible form of implementation, the electric motor also provides electrical power generation when the vehicle coasts. This arrangement is generally preferred since it is simpler; a single electrical machine is used in which the transition between a drive mode and generation mode is managed by an electronic control, that will be described later.

Alternatively, a separate generator can be provided that is independent from the drive motor. This arrangement can be used in power train configurations where the wheels that drive the vehicle and the wheels that drive the generator are not the same. For example, when the wheels driving the vehicle are the front wheels, the generator can be mechanically coupled to the rear wheels to generate electrical power when the vehicle coasts. In another example, the driving connection between the generator and the wheels is selectable, in the sense that the generator can be coupled to one wheel or to multiple wheels. This arrangement permits to manage regenerative braking on the different wheels independently of each other. This arrangement also permits to put one wheel in a drive mode and another wheel in the regenerative braking mode.

When a single generator is being used in an arrangement where it selectively connects to different wheels, the driving arrangement would typically include separate power channeling paths from each wheel to the generator that can be enabled or disabled by a clutch mechanisms. A power channeling path can include a drive shaft from the respective wheel to the generator. A clutch connects the drive shaft to the generator. The state of the clutch determines if the respective wheel drives the generator. If the clutch is opened then no driving relationship exists and the wheel manifests no regenerative braking. When the clutch is closed, the wheel drives the generator and regenerative braking is applied to the vehicle through that wheel.

In the specific example shown in FIG. 1, the electric motor/generator 18 is connected to the wheels 12, 14 by a transmission 20. The connection between the electric motor/generator 18 is made by a rotary coupling 22. The transmission connects to the respective wheels 12, 14 by half-shafts 24, 26.

The transmission 20 can be a single speed transmission, in other words it does not provide a fixed ratio between the input, which is the rotary coupling 22 and the output which is the half-shafts 24, 26. Alternatively, the transmission can include multiple ratios that can be shifted electronically or manually by the driver. The transmission 20 can also be a Continuously Variable Transmission (CVT) that provides an infinite number of ratios in given range.

In addition, the transmission 20 is provided with a differential function to allow the wheels 12, 14 to turn at different speeds when the vehicle 10 is turning.

A control module 28 controls the supply of electrical power from the battery 16, when the electric motor/generator is in the drive mode, in other words it drives the wheels 12, 14, and also controls the reverse flow of electrical power, when the electric motor/generator 18 is in the regeneration mode producing electrical power used to re-charge the battery. The structure and operation of the control module 28 will be discussed in greater detail later.

A heating system 30 is also coupled to the control module 28. The heating system 30 is used to generate thermal energy for heating the cabin of the vehicle 10. The heating system 30 uses resistive elements that that are supplied with electrical power from the battery 16, the electric motor/generator 18 or both, under the control of the control module 28.

Note that the heating system 30 can also be configured to heat the battery 16, in addition to heating the vehicle cabin. It is well known that a battery looses effectiveness when operated in low temperatures and it is advantageous to warm up the battery in order to get it to operate better.

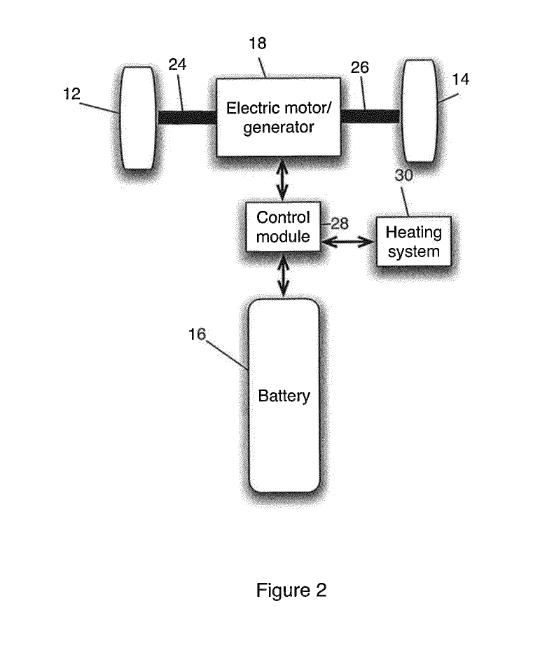

FIG. 2 of the drawings illustrates another power train configuration which is similar to the one discussed in connection with FIG. 1, with the exception that the electric motor/generator 18 is located between the wheels 12, 14. Note that in this arrangement, differential function is integrated into the electric motor/generator 18 allowing the wheels of the vehicle to rotate at different speeds when the vehicle 10 is turning.

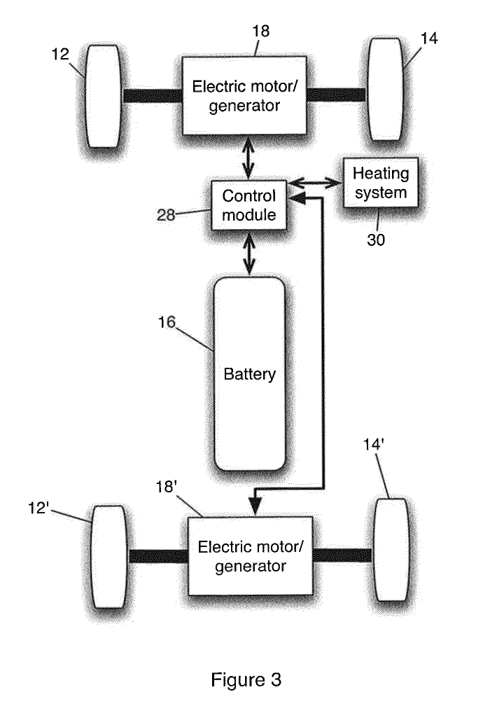

FIG. 3 provides another power train configuration example in which the four wheels of the vehicle are driven and can be used for propulsion. In this example, two separate electric motor/generator assemblies 18, 18′ are provided. The electric motor/generator 18 is integrated in the front axle, while the electric motor/generator 18′ is integrated in the rear axle (Note: the expression “axle” is notional only and refers to the axis of rotation of the front or rear wheels, since no physical single axle per wheel set may be present in some forms of implementation). The control module 28 communicates with the both electric motor/generators 18, 18′ and controls them independently.

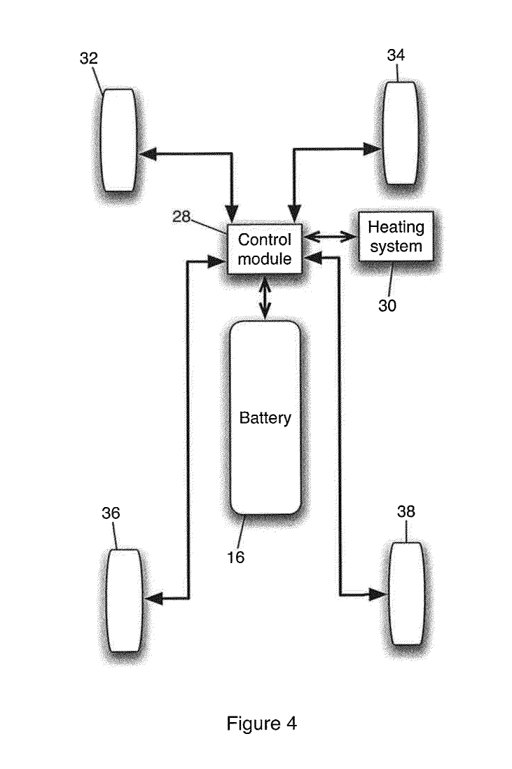

FIG. 4 is yet another example of implementation of the power train. In this example the electric motors/generators are integrated into the wheels of the vehicle. Specifically, the vehicle has four wheels 32, 34, 36 and 38. An electric motor is integrated in each wheel for propulsion when the electric motor is in the drive mode and for electrical power generation when in the generation mode. In this embodiment the electric motor/generator is mounted and forms part of the rotating assembly that is suspended by a spring and shock absorber which cushion the vehicle from road conditions.

Alternatively, the electric motors/generators may be mounted to the frame of the vehicle, instead of being integrated to the wheels, and drive the wheels through short drive shafts.

In both examples of implementation, however, each wheel of the vehicle is independently driven and also independently controlled for regenerative braking.

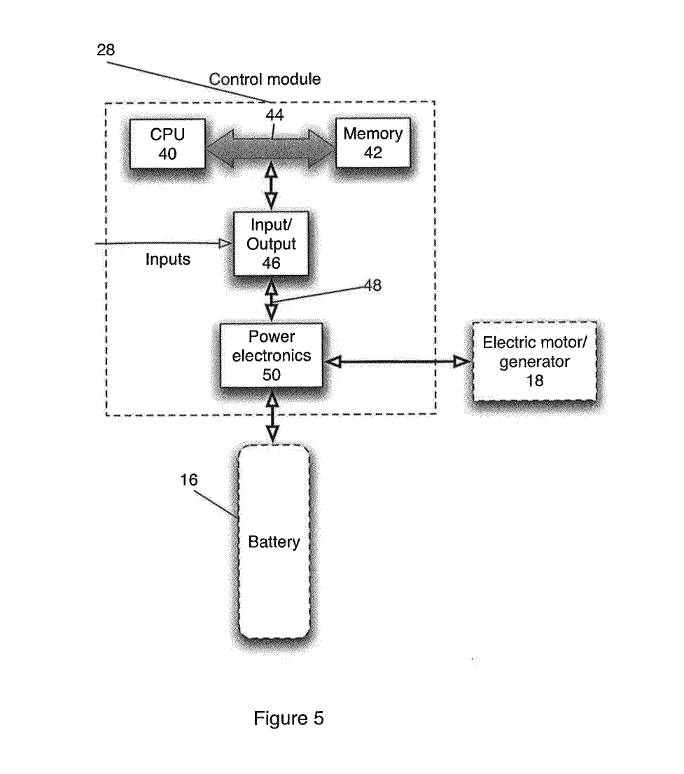

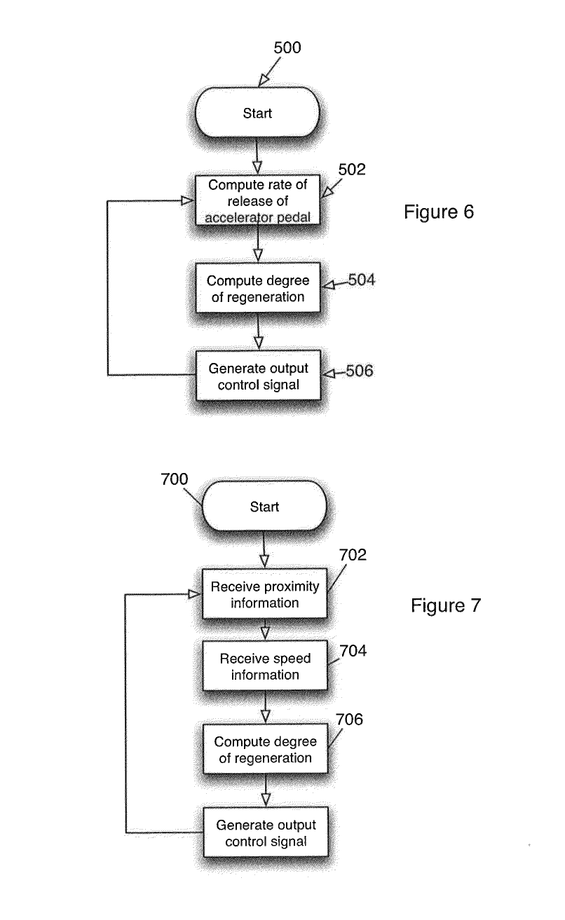

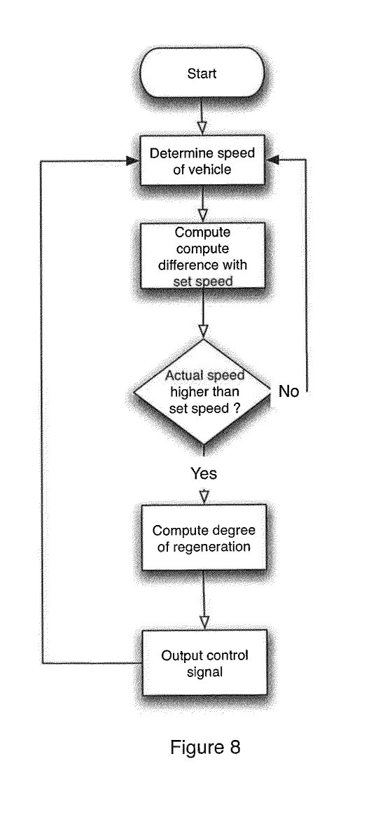

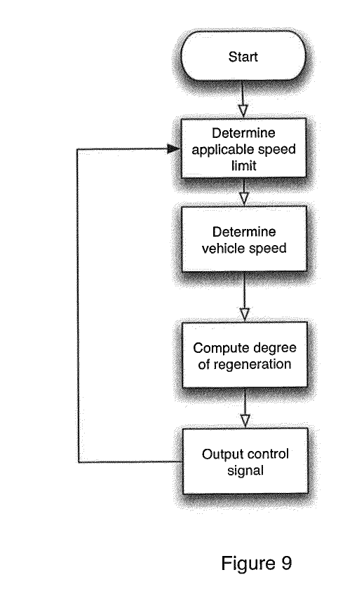

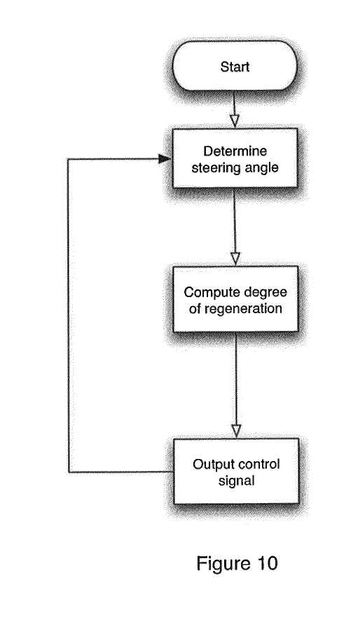

The structure of the control module 28 is illustrated in detail in FIG. 5. The control module is essentially a computing platform that runs a regenerative braking control logic and also includes power electronics which control the electric motors of the vehicle in generation mode in order to implement the logic.

More specifically, the control module 28, includes a Central Processing Unit (CPU) 40 that is connected to a machine readable storage 42 by a data bus 44. The machine readable storage 42 is encoded with non-transitory software that is executed by the CPU 40 to implement the regenerative braking logic. The machine readable storage 42 can also include a database correlating position coordinates with road information allowing to determine the position of the vehicle 10 on a particular road. The database can include additional information that will be described later.

An Input/Output (I/O) module 46 receives various input signals that are processed by the software and that condition how the regenerative braking will be managed. In the drawing, the input signals are collectively identified by the arrow “Inputs”, it being understood that the signals may or may be either combined and travel over a single pathway or be directed to the I/O 46 over separate pathways.

A control signal 48 is output from the I/O 46 and directed to a power electronics module 50 which implements the regenerative braking action or effect computed by the software. In turn, the power electronics module 50 is connected to the electric motor/generator (in the example shown, a single electric motor/generator illustrated, it being understood that when the vehicle has several electric motors/generators the power electronics module 50 is connected to each one to control it independently) and to the battery 16. in the embodiment the vehicle has a heating module 30, such as shown in FIGS. 1 to 4, the electronics module 50 is also connected to the heating module 30.

The inputs applied at the I/O 46 include the following:
1. Accelerator position signal—a digital or an analog signal that conveys the position of the accelerator pedal. For example, the accelerator position signal would indicate whether the accelerator pedal is fully depressed, which indicates a demand for maximal acceleration, fully released which indicates that no or minimal drive power or any intermediate position.
2. Vehicle speed signal—a digital or analog signal indicative of the speed at which the vehicle is traveling. The vehicle speed signal can also indicate the speed of individual wheels of the vehicle, in addition to the overall speed of the vehicle.
3. Steering angle signal—a digital or analog signal indicating how much the steering is turned from a neutral position, in which the vehicle travels in a straight line. In addition to the degree of steering input the signal also indicates if the steering is turned to the right or to the left.
4. Brake input signal—a digital or analog signal indicating how much brake effort is being applied by the driver. The brake input signal can include a pressure sensor coupled to the hydraulic brake pressure lines to measure the pressure of hydraulic fluid that is acting against the brake pads. Generally stated, this information indicates how much the friction brakes are being used by the driver. Note that an electric vehicle may provide braking action by regeneration which is triggered by depressing the brake pedal. In such case the braking action can be solely provided by regeneration, it can be a blended effect combining regeneration and friction brakes or largely friction brakes, depending on the degree pressure applied on the brake pedal. Light brake application would only invoke additional regeneration braking with no friction brakes effect. A higher braking effort by the driver will progressively invoke the friction brakes up to a point where the friction brakes are the main braking mechanism of the vehicle. In addition to the pressure sensor, the brake input signal can convey information on the degree of regeneration that is being applied when the brake pedal is being initially depressed.
5. Acceleration signal—a digital or an analog signal indicating the degree of acceleration to which the vehicle is subjected. The acceleration signal can be generated from an accelerometer mounted in the vehicle which can measure acceleration along different axes. For example, the accelerometer can convey information about braking (how hard the vehicle is braking) or speed increase (how fast the rate of the vehicle is increasing). In addition, the accelerometer can also indicate the degree of lateral acceleration during turns. Also, the acceleration signal can also indicate the inclination of the vehicle with relation to a vertical axis.
6. Rotation rate signal—a digital or an analog signal that indicates how much the car is turning about a vertical axis. Rotation rate can be measured by using a yaw sensor.
7. Desired regenerative braking signal—a digital or analog signal generated by a control that is manually operated by the driver which indicates the degree of regeneration desired. This control can be operated while the vehicle is in motion and provides a continuous range of positions which correspond to an increasing regenerative braking. In a specific example, the control can be a paddle-like lever that is mounted behind the steering wheel and that can be operated by the driver with one hand. The paddle can be pulled toward the steering wheel to increase the regenerative braking; the degree with which the paddle is depressed indicates the degree of regenerative braking desired. The relationship between the degree of displacement of the control versus the degree of regenerative braking can be linear or non linear. For instance, the degree of regenerative braking can be increased exponentially as the control is near the end of its range of travel.
8. Proximity information—a digital or analog signal that indicates how close the vehicle 10 is from another vehicle, such a vehicle that precedes the vehicle 10. The signal can convey distance information, in other words indicate the distance separating the two vehicles. Additionally the signal can convey rate of change information, such as the rate at which the distance between the vehicles change and also indicate if the distance increases or decreases. The signal can be obtained from a proximity sensor that is mounted on the vehicle 10. A proximity sensor that uses a laser beam can be used for this purpose.
9. Position information—a digital or analog signal that provides information about a position of the vehicle with relation to a reference. The position information signal would typically be derived from an external infrastructure such as a Global Positioning System infrastructure. Specifically, the position information conveys the coordinates such as latitude and longitude allowing determining the location vehicle relative to a certain reference. In addition to the latitude and longitude, the position information signal can be designed to convey altitude information, in other words the elevation at which the vehicle is currently located.

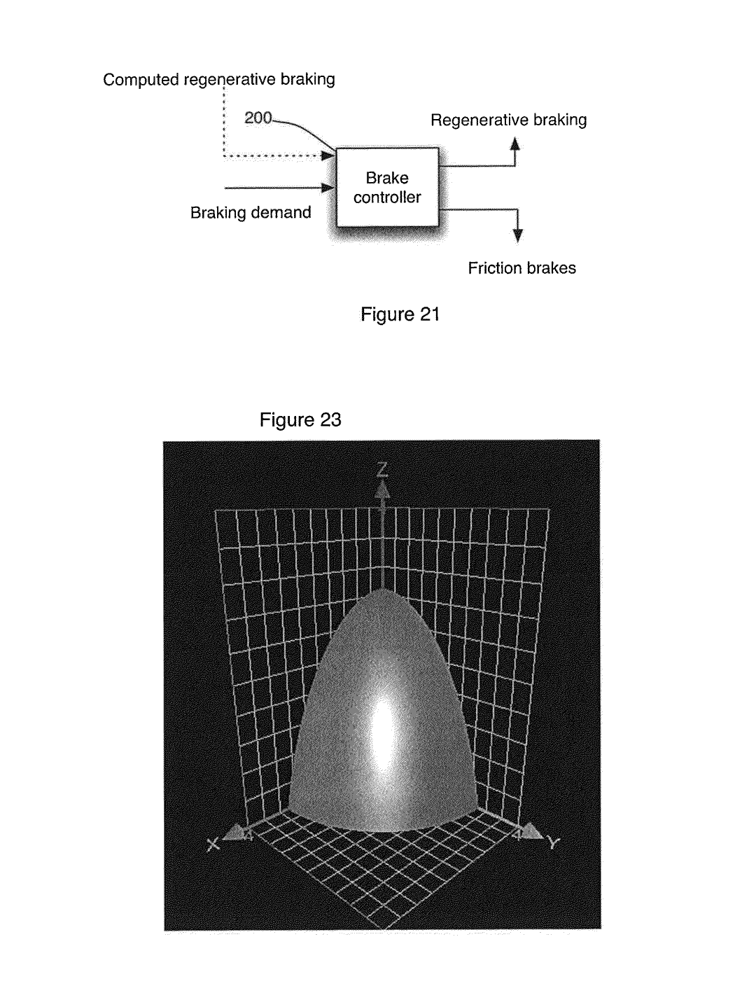

FIG. 21 illustrates the block diagram of a braking controller of the vehicle 10. The braking controller 200 is computer based and controls the braking of the vehicle by executing software which implements the various functions of the braking controller 200. In one possible form of implementation, the braking controller 200 can be integrated in the control module 28, in other words, the braking controller 200 includes a software component executed by the CPU 40 and also includes a series of actuators to operate the friction brakes of the vehicle 10. Alternatively, the braking controller 200 is a stand alone unit that interfaces with the control module 28 but mostly operates independently.

The braking controller 200 manages the braking function of the vehicle 10 by regulating regenerative braking and also friction brakes. The braking controller is triggered when the driver presses on the brake pedal. The primary input to the braking controller is a braking demand signal. The braking demand signal indicates how strongly the brakes are to be applied. The braking demand signal can be a brake stroke signal, which is the degree with which the brake pedal is being depressed. Alternatively, the braking demand signal can be a brake pressure signal, in other words the a signal that conveys the pressure with which the driver is pressing on the brake pedal.

The brake controller 200 has two outputs. The first is a regenerative braking output which typically further increases the degree of regenerative braking that is implemented upon release of the accelerator pedal and before the brake pedal is depressed. The regenerative braking is the initial braking action. I

The second braking output is the friction brakes output. The friction brakes output controls the intensity with which the friction brakes are being applied.

Normally, the braking activity starts with regenerative braking and progressively blends-in the friction brakes. When the driver starts to apply the brakes the initial braking action is regenerative braking only. If the braking demand is relatively low, only regenerative braking is used. However, the ability of regenerative braking to decelerate the vehicle 10, depends on the speed of the vehicle 10; the higher the speed the higher the deceleration. At a certain point, when the speed of the vehicle 10 is significantly reduced, the regenerative braking effect also diminishes where it can no longer provide the braking action that is consistent with the braking demand. At that point the friction brakes are engaged progressively to further decelerate the vehicle.

The brake controller 200 is designed to invoke the friction brakes in a way to provide a progressive braking action such that the driver cannot tell that a different braking mechanism is now acting. Thus the transition from regenerative braking to friction braking is thus transparent to the driver.

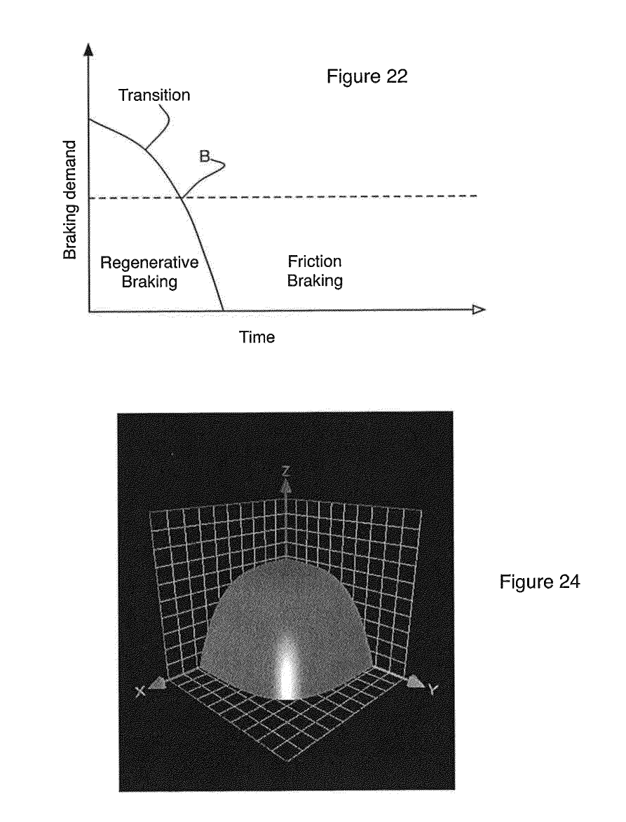

FIG. 22 is a graph which illustrates the operation of the braking controller 200 showing the transition between regenerative braking and friction braking. Note that the graph is simplified for illustration purposes and clarity. For a constant braking demand, which is illustrated by the dashed line A, the initial braking is regenerative only. Regenerative braking is maintained up to point B where it is at its maximum. Beyond point B, the regenerative braking is not able to maintain the desired level of deceleration and the friction brakes are then invoked.

Note the transition area between the regenerative braking zone and the friction braking zone is not a straight line rather a curve; the higher the braking demand the sooner the friction brakes are invoked.

### Description of Control Algorithms

1. Controlling Regenerative Braking Based on the Rate at which the Accelerator Pedal is being Released.

The rate at which the accelerator pedal is being released is an indicator of the driver's intent to reduce the vehicle speed very quickly, such as during an emergency situation when the driver needs to avoid a collision. In such an instance the degree of regenerative braking is increased by comparison to a situation in which the accelerator pedal is released more gently. In this fashion, the higher level of regenerative braking provides the benefit of reducing the vehicle speed in an appreciable manner even before the driver has depressed the brake pedal.

The process is described in greater detail in connection with FIG. 5, which is a flowchart illustrating the various process steps that are performed continuously as the vehicle is in motion. The process starts at 500. At step 502, the software monitors the accelerator position sensor and computes rate information. More specifically, the software determines how the position of the accelerator varies with relation to time and computes a rate of release. The rate of variation indicates how fast the pedal is being released, hence the driver's intent.

In a variant, the software can also compute a confidence factor which indicates the degree of confidence that the computed rate of accelerator pedal release reflects the driver's intent. The confidence factor takes into account the range of travel of the accelerator pedal over which the a certain rate of release has been observed. The confidence factor avoid unnecessary changes to the regenerative braking resulting from minute accelerator pedal excursions, which occur normally when the vehicle is being driven and which may not indicate the existence of a condition requiring increased regenerative braking.

In a specific example of implementation, the confidence factor progressively increases with the accelerator pedal travel. If the accelerator pedal is released suddenly from a position that corresponds to a 10% of its range of travel, then the confidence factor is nil, which translates in no change to the regenerative braking, even if the rate of the accelerator pedal release is high. If the range of travel is higher, the confidence factor is no longer nil and progressively increases to a maximum where the accelerator pedal is fully depressed.

The confidence factor can be a value in the range from 0 to 1. 0 being associated to an accelerator pedal travel of less than 10%, while 1 corresponds to a full range of travel of the accelerator pedal. The process computes at step 504 the degree of regenerative braking on the basis of a blended factor A that takes into account both the confidence factor and the rate of accelerator pedal release. The confidence factor multiplies the computed rate of release which yields the blended factor A that is used to compute directly the degree of regenerative braking.

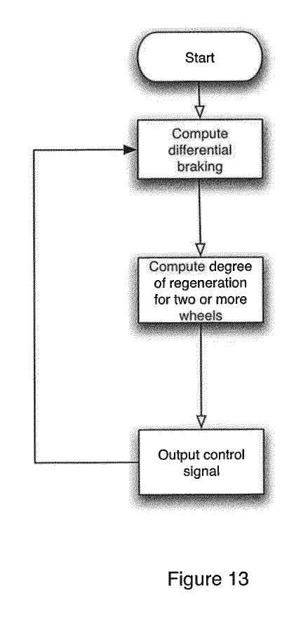

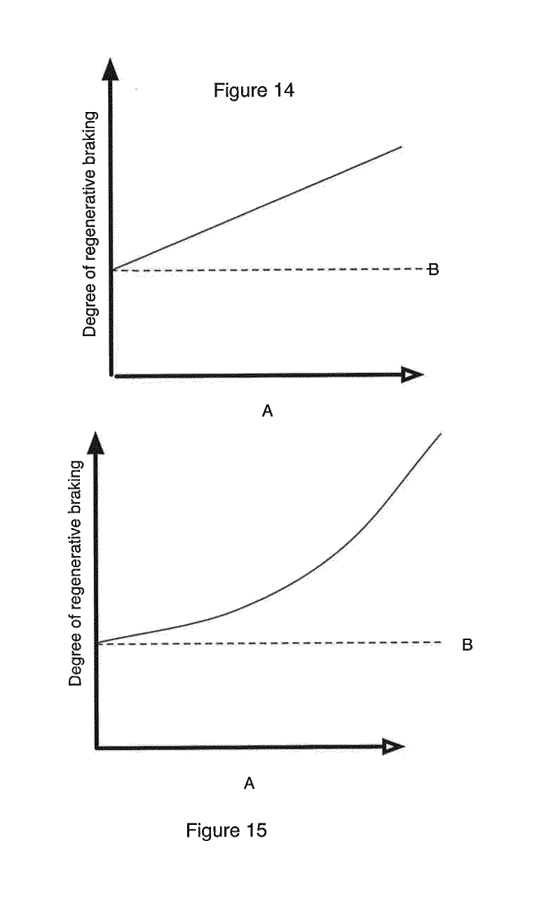

FIG. 13 is a graph illustrating an example of a relationship between the degree of regenerative braking and the blended factor A. Regenerative braking intensity B corresponds to a situation where no increase in regenerative braking is necessary, either because the rate of release is small or the confidence factor is nil or near nil. The rate of regenerative braking increase versus blended factor A depends on the slope of the line; this slope can vary depending on the intended application.

Alternatively, the relationship between the degree of regenerative braking intensity and the blended factor A can be non-linear, as shown by the graph in FIG. 13.

In terms of specific implementation, the control module 28 uses a look-up table in the relationship between different values of the blended factor A are mapped to respective values of the degree of regenerative braking. Alternatively, the control module may compute the degree of regenerative braking using an input the blended factor A, by using an algorithm that represents the desired relationships.

In a possible variant the process shown at FIG. 5 may implement a degree of hysteresis to avoid unwanted rapid regenerative braking intensity changes. The hysteresis can be implemented by introducing some degree of lag in the system. For example, once the regenerative braking has been increased as a result of a rapid release of the accelerator pedal, the regenerative braking can diminish only after a certain amount of time has elapsed. This amount of time can be selected as desired according to the application. In such case the process will ignore the behavior of the accelerator pedal that yields a reduced regenerative braking. Such reduced regenerative braking will be implemented only after the preset time period has elapsed.

Referring back to flowchart on FIG. 5, the process step 506 releases an output control signal that conveys the computed degree of regenerative braking. This output signal is then conveyed to the power electronics module 50 via the I/O 46 to be implemented.

### 2. Adaptive Regenerative Braking Based on Driver Behavior or Road Type.

The adaptive regenerative braking algorithm is designed to learn from the behavior of the driver to adjust the degree of regenerative braking upon release of the accelerator pedal such as to increase the vehicle efficiency, in terms of converting kinetic energy into electrical energy. Driver behavior reflects the way the driver operates the vehicle in terms of driving preferences but also the type of road on which the vehicle travels.

The adaptive regenerative braking algorithm has two components which can be used individually or in combination. One component increases the regenerative braking in instances when the driver is relying too much on friction brakes to stop the vehicle. The other component reduces the regenerative braking when the accelerator pedal is operated according to an oscillation pattern, which indicates that when the accelerator pedal is being released, the applied degree of regenerative braking slows the vehicle too much, which in turn requires application of further propulsion power to keep the vehicle at the desired speed.

The first component of the algorithm is shown at FIG. 15. The process starts at step 1500. Step 1502 determines the degree at which the driver is using the friction brakes to stop the vehicle. In normal driving conditions, such as in an urban environment the normal driving pattern is to accelerate from a stop to moderate speed and then stop again, at a traffic light or stop sign. Stopping the vehicle by operation of the brake pedal can be done in various ways which affect the effectiveness of the regenerative braking. If the braking action is initiated early enough, most of the kinetic energy can be bled-off via regeneration which is obviously desirable. Braking late is less desirable because in those circumstances the friction brakes are being relied upon more, which wastes energy since the kinetic energy of the vehicle is converted into heat.

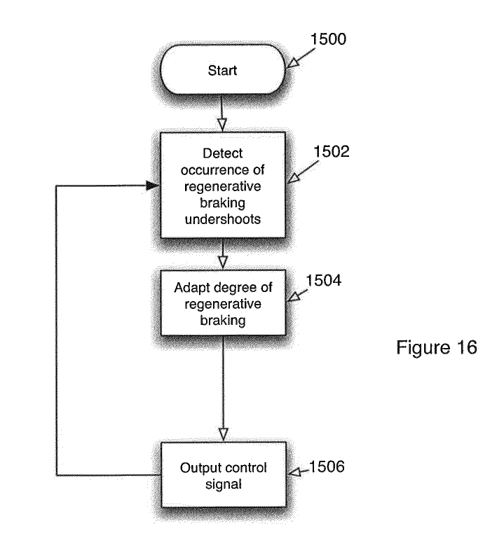

FIG. 16 illustrates an example of a method for determining the degree of use of the friction brakes. The brake input signal can be used for the calculations, in particular the component of that signal which conveys the hydraulic brake pressure.

The graph in FIG. 16 plots the variation of the pressure in the hydraulic brake system versus time. It shows two different brake patterns. Pattern A is translates into a more aggressive braking than pattern B. Specifically, in pattern A the pressure in the brake system starts to increase at time T0, which coincides with moment at which the friction brakes are engaged. The pressure increases progressively as the brake pedal is further pushed. The brake pressure is maintained at T1 where the vehicle is at a complete stop.

Braking pattern B is similar in terms of curve shape; it shows a pressure ramping up portion and plateau, however the overall hydraulic pressure is much lower than braking pattern A.

Pattern B reflects a situation where the braking action has been initiated at an earlier stage, where a larger amount of the kinetic energy of the vehicle has been converted through regeneration into electricity. In contrast braking pattern A uses the friction brakes more. This occurs when the braking action is triggered later, leaving less opportunity to use regeneration. For clarity, the expression “braking action” refers globally to the mechanisms for braking the vehicle and include regenerative braking and friction braking. The braking action thus begins when the accelerator pedal is released which invokes regenerative breaking, that is increased when the brake pedal is depressed. The braking action terminates with the application of the friction brakes.

The area under each curve is an indicator of the degree of use of the friction brakes. The area for pattern A is much larger than the area for pattern B. Process step 1502 therefore computes the area under the curve by integrating the brake pressure over the time interval T0-T1. T1 is determined by reading the vehicle speed from the vehicle speed sensor.

To avoid making adjustments to the regenerative braking intensity when the accelerator pedal is released and before the brake pedal is depressed, the method collects friction brake use data over a number of braking cycles. The information for a number of brake cycles is collected and averaged to obtain an average value.

Step 1504 adjusts the regenerative braking intensity upon release of the accelerator pedal based on the average friction brake use data. The overall objective of this adjustment is to adapt the regenerative braking to the individual driving style and also to the immediate driving conditions. The algorithm at step 1504 would stepwise increase the regenerative braking action effective before the friction brakes are fully applied in order to reduce the area under the curve, such that a larger fraction of the kinetic energy will be converted into electricity instead of being wasted into heat.

Step 1506 outputs a control signal that is directed to the control module 28 to implement the adjusted regenerative braking action.

The process described in the flowchart of FIG. 15 constantly repeats and makes adjustments. The rate at which those adjustments are made can vary and may be function of user preference. Some users may prefer to experience the same degree of regenerative braking which would provide a consistent driving experience. In such case, adjustments to the regenerative braking can still be made but at a slower rate, by collecting friction brake use data over longer time periods before making adjustments to the degree of regenerative braking.

For users that easily adapt to a varying degree of regenerative braking, more aggressive adjustments can be made without creating uncomfortable driving conditions. Since the degree of adjustment is a matter of preference, the vehicle may be provided with a user operated control that indicates if the driver desires the regenerative braking adjustment function to operate and in the affirmative the degree of aggressiveness of the adjustability. The user operated control can be any type of control on the dashboard of the vehicle allowing to specify if the function is active or not active and if active the range of aggressiveness.

In a possible variant, the degree of use of the friction brakes may be inferred by the acceleration signal. Beyond a certain rate of negative acceleration, the system assumes that the friction brakes have been invoked and perform the above described computations such as to adjust the degree of regenerative braking acting on the vehicle upon release of the accelerator pedal and before the brake pedal is being depressed.

In another variant, the output signal from the brake controller 200 which commands the friction brakes can be used as input to the algorithm, instead of using a pressure sensor or acceleration sensor. Since the friction brakes output signal commands directly the application of the friction brakes, it conveys accurately when the friction brakes are being used, how hard they are being applied and how long they are being applied.

In another possible variant the above described process can also use other inputs to provide a more refined adjustments to the regenerative braking, in particular to avoid an excessive increase to the regenerative braking that could be unnatural to the driver.

If the regenerative braking is too intense it may create a situation where the vehicle slows down too rapidly and then requires application of motive power to move as the driver intends it. For example, if the vehicle is approaching a traffic light or stop sign, the driver releases the accelerator pedal and the regenerative braking action is initiated. However if the regenerative braking is too strong, the vehicle slows down too fast and would practically stop way before the traffic light stop line is reached. In such case, the driver would need to press the accelerator pedal to move the vehicle forward such as to bring it to the stop line.

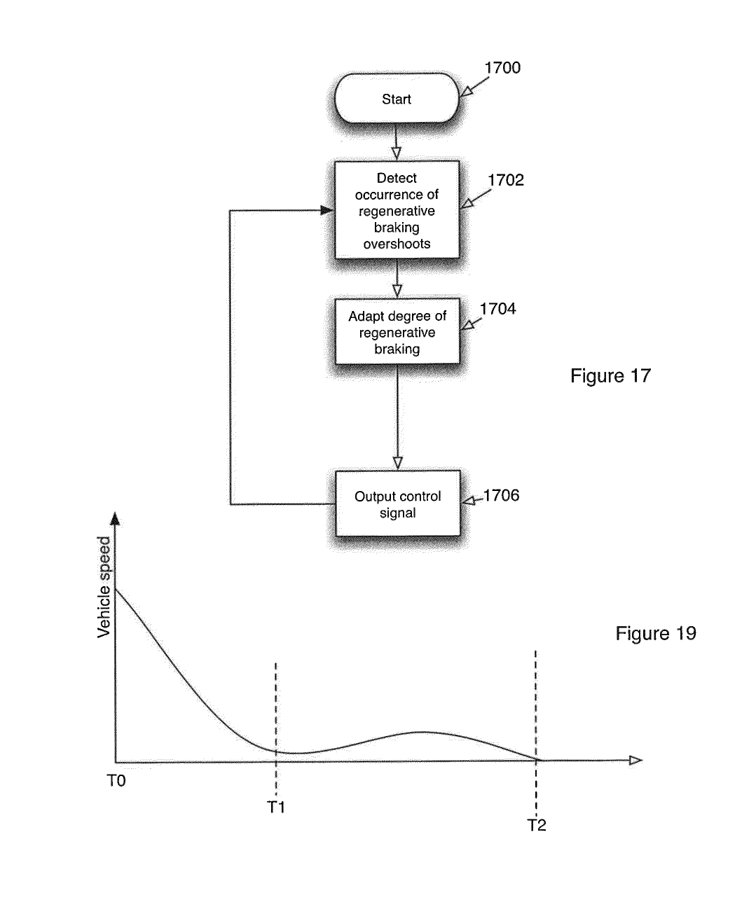

To alleviate this possible drawback, the process described in the flowchart of FIG. 17 can be used. This process is performed in conjunction with the process in FIG. 15 and essentially determines when the regenerative braking has been increased too much and need to be scaled back some.

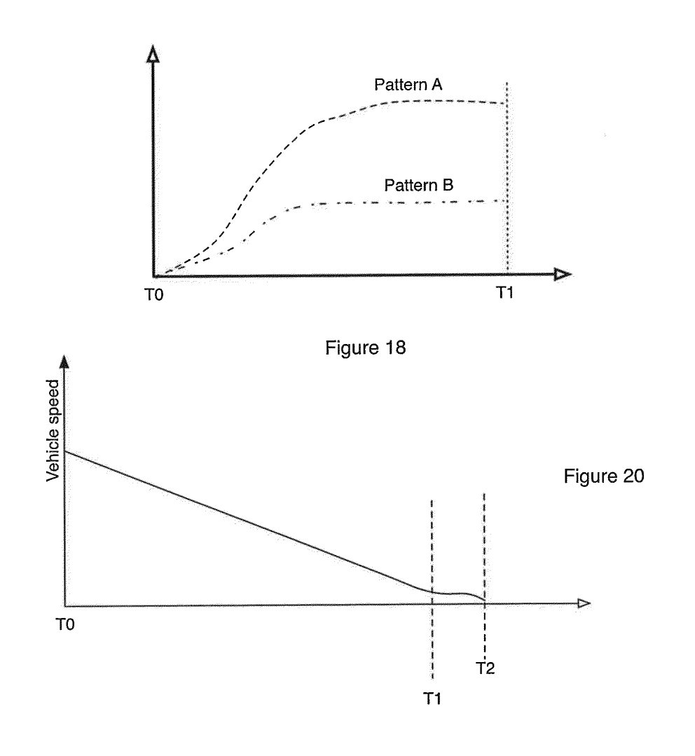

The process starts at 1700. At step 1702 the system determines if the driver needs to compensate for excessive regenerative braking. The need for compensation is sensed by observing the accelerator position signal for motion patterns which indicate the application of motive power to the wheels following regenerative braking activity. With reference to the graph on FIG. 18, which illustrates the vehicle speed immediately prior the vehicle stops at a stop sign or a traffic light, it can be seen that at T0 the speed of vehicle starts to decline, due regenerative braking resulting from the release of the accelerator pedal. In this scenario, it is assumed that no brakes are being applied, regenerative or friction. Note that the speed decrease is shown as being linear between the segments T0 and T1. This is not always so as the decrease can be non linear also.

At T1, the speed of the vehicle has been reduced almost to the point of bringing the vehicle to a complete stop. The minimal forward motion is creep forward effect that is usually built into electric cars to simulate the behavior of vehicles using an internal combustion engine and having an automatic transmission. In other words, when there is no power application and no brake application, the vehicle moves forward at a speed in the order of a couple of kilometers an hour.

The vehicle is practically stopped but it is too far away from the stop line and the driver commands some forward motion to move it forward. This is shown by the increase in speed in the interval from T1 to T2. At mid-point in this interval, the speed decreases, as the vehicle gets closer to the stop line. At T2, the vehicle speed is brought to the desired stop location and its speed is zero. The vehicle is held in this position by the application of the brakes.

FIG. 19 illustrates a different scenario where rate of regenerative braking and the timing of release of the accelerator pedal is such that no compensation by the driver is necessary. In this scenario, the regenerative braking slows the vehicle down in the interval T0-T1, however T1 occurs shortly before the desired stop location and there is no need for the drive to apply power. the vehicle is simply left to creep forward and at T2 the brakes are applied to fully stop the vehicle.

The detection of driver compensation for excessive regenerative braking can be done by performing signal processing on the vehicle speed to detect the pattern shown in FIG. 18. One example is to compute the area under the curve in the interval T1-T2. T1 is detected when the accelerator pedal is depressed and T2 is detected when the vehicle speed is zero, or when the brakes are being applied.

Step 1704 adapts the degree of regenerative braking by reducing it by some degree. Step 1706 outputs the control signal based on the computed degree of regenerative braking determined at step 1704. As in the case of the process at FIG. 15, the process at FIG. 17 constantly repeats to provide a continuously adaptive behavior.

Assuming a consistent driving behavior and identical driving conditions (for instance urban driving), if the process of FIG. 15 increases the regenerative braking too much, more compensation by the application of power will be observed by the process of FIG. 17. The ideal scenario is one where the degree of usage of the friction brakes is the least, while there is little or no need for compensation by the application of power.

The opposing processes at FIGS. 15 and 17 can be managed by using an arbitration function which provides some degree of priority of one over the other. For instance, the system may be designed such that priority is given to the process which aims to reduce the usage of the friction brakes and maximize regenerative braking for greater efficiency. In such case the process will likely progressively increase the regenerative braking up to a point where it is held back by the process at FIG. 17. In other words, the regenerative braking is progressively increased and then increase stops because the driver needs to compensate by the application of power.

The logic provides regenerative braking which is adaptive for driver behavior and driving conditions. For more aggressive drivers, that brake late the point of equilibrium between the two opposing processes will likely occur at a relatively high degree of regenerative braking. For less aggressive drivers the equilibrium will occur at a lesser degree of regenerative braking. In terms of driving conditions, the point of equilibrium will shift depending on how often and how hard the vehicle needs to brake. In urban driving, where the vehicle needs to be often brought to a complete stop, more regenerative braking will result by comparison to a highway driving where the vehicle travels at higher speeds and does not stop as often.

The degree of braking regeneration can be expressed in terms of braking torque generated by the electric motor. The amount of braking torque produced is not necessarily constant over the braking event and may vary linearly or non linearly. Reference in this specification to “increasing” or “decreasing” regenerative braking means that the braking torque is increased or decreased at some point, but those terms do not imply that the torque is held constant or follows any particular mathematical relationship.

### 3. Adaptive Regenerative Braking Based on Proximity and Speed Information

This algorithm controls the magnitude of regenerative braking to provide increased regenerative braking when the vehicle is close to another object. For example, when the vehicle follows another vehicle closely, the regenerative braking is increased such that the trailing vehicle will be able to reduce its speed more rapidly if the leading vehicle suddenly brakes. This increased regenerative braking action occurs before the brake pedal has been depressed.

In other words, the closer the trailing vehicle is to the leading vehicle, the greater the regenerative braking will be. Optionally, the regenerative braking can also modulated based on the speed of travel of the vehicle; the faster the vehicle travels, the larger the increase in the regenerative braking.

FIG. 7 is a flow chart illustrating the process steps for adapting the magnitude of the regenerative braking which is implemented when the driver commands the vehicle to discontinue the application of driving force but before the brake pedal is depressed. The driver commands the vehicle to discontinue the application of driving force when the driver releases the accelerator pedal.

The process starts at step 700. At step 702 the proximity information signal is received. The proximity information signal indicates how close the vehicle is from a obstacle in front of the vehicle, such another vehicle, when both vehicles travel on a road, following one another.

At step 704, the signal conveying speed information is received. The speed information indicates how fast the vehicle is traveling.

Step 706 computes the degree of regenerative braking. An example of a relationship between the degree of regenerative braking and the proximity and speed information is shown at FIG. 23 that can be used as a basis for the computation at step 706. In that figure the Z axis represents the magnitude of the regenerative braking, the higher the value on that axis the higher the regenerative braking torque is. The X axis represents the proximity information expressed in terms of distance from the obstacle. The higher the value on the axis, the higher the distance, hence the lower the proximity. The Y axis is the inverse of the speed information; the higher the value the lower the speed. The relationship defines a surface bound between the x-z, y-z and x-y planes. For a relatively high speed and relatively high proximity, the operational point on the x-y plane will be close to the origin and corresponds to relatively high regenerative braking torque value.

In a possible variant, the processing of the proximity information includes computing the rate of change of the proximity, which can be used yet as another factor to determine the magnitude of the regenerative braking to be implemented. For instance, the relationship between proximity, regenerative braking and speed can be defined as a series of maps, of the type shown in FIG. 23, different maps represent different rates of change of the proximity. As the rate of change increases, which means that the distance between the vehicle and the obstacle is being reduced (or increased) more rapidly, then the response becomes more aggressive.

FIG. 24 is an example of a map that provides a more aggressive response than the one in FIG. 23. By more aggressive is meant that for the same proximity and speed values, the regenerative braking in FIG. 23 will be lower than the one in FIG. 24. FIG. 24 is the response map that corresponds to the a higher rate of the proximity change.

Accordingly, the algorithm computes the rate of proximity change and on the basis of that rate selects a map and then computes the regenerative braking. It is understood that the process is continuous and operates essentially in a loop, where the computation of the regenerative braking to be implemented should the driver starts releasing the brake pedal is constantly repeated.

Another variant is to tie the dynamically adjusted regenerative braking magnitude to the braking function which is managed by the brake controller. The purpose of the interaction with the braking controller is to provide a additional increase in braking, above what the regenerative braking provides, upon actuation of the brake pedal. In other words, as the regenerative braking is adjusted upwards, the braking is also adjusted upwards.

The adjustment of the brake action provided by the brake controller is provided by communicating the computed regenerative braking magnitude to the brake controller 200. As shown in FIG. 21, the computed regenerative braking information is shown by the arrow in dotted lines. The information is processed by the brake controller 200 that is then capable to determine the degree of further regenerative braking and/or friction brakes to achieve the desired degree of braking based on braking demand.

### 4. Adaptive Regenerative Braking Based on Terrain Information

The regenerative braking can be adapted based on terrain information. By terrain information is meant topology information with reference to elevation, such as mountains and valleys. The regenerative braking can be adjusted depending on whether the vehicle travels a road a hill a road that descends a hill to provide a more enjoyable driving experience and/or a more efficient driving. For example, when the vehicle climbs a hill the regenerative braking is reduced to take into account the gravity that slows the vehicle, when the propulsion demand ceases, such as when the driver releases the accelerator pedal. Conversely, when the vehicle descends the hill, gravity is acting in a reverse direction and the regenerative braking is increased when propulsion demand ceases.

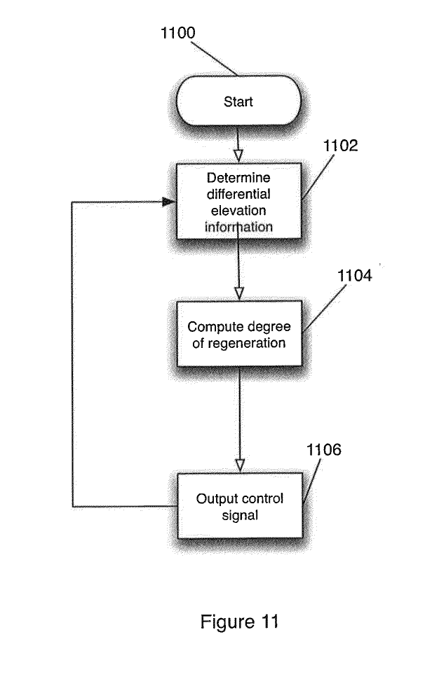

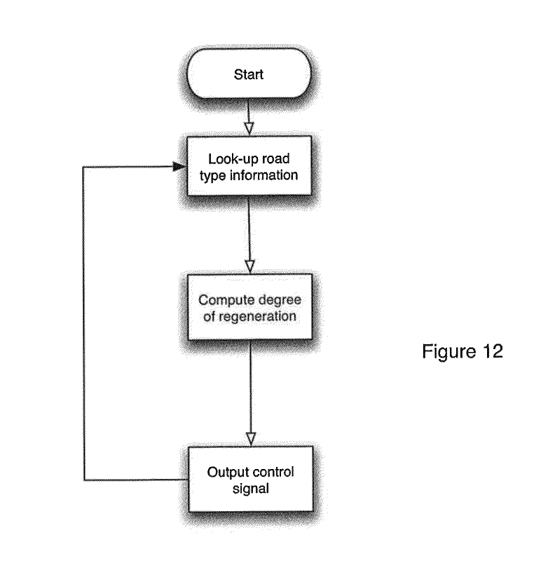

FIG. 11 illustrates the general process for adjusting the regenerative braking based on terrain information. The process starts at 1100. At step 1102 the algorithm gathers differential elevation information. More specifically, the algorithm determines an upcoming road elevation feature on the basis of which it determines if the vehicle would be climbing or descending and the rate of climb or descent.

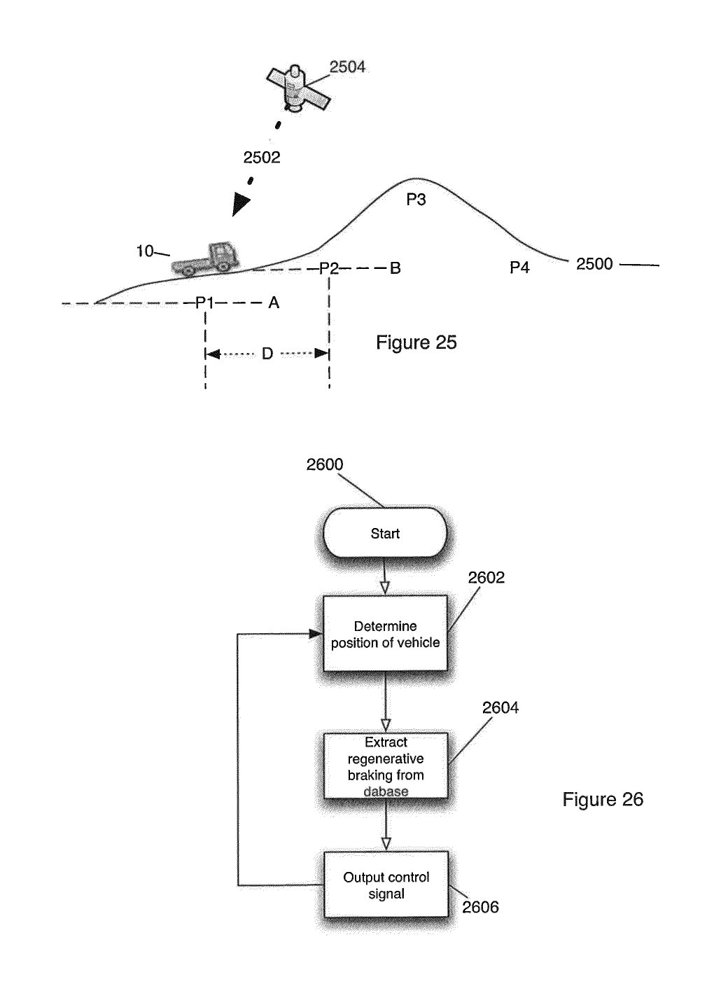

FIG. 25 provides a more specific example of the process for determining the differential elevation information. Assume the vehicle 10 travels on a road 2500. The vehicle 10 receives a position signal 2502 from a GPS infrastructure 2504. The algorithm correlates the position information with the road database represented by the memory 42 to locate the vehicle 10 on the road 2500. The road database also contains elevation information, more particularly information identifying the elevation at multiple positions on the road. When the vehicle 10 is at position P1 it extracts from the database the elevation information, such as altitude A. Note that the current elevation information can also be obtained from the GPS position signal which in addition to conveying latitude and longitude coordinates conveys altitude information.

Since the vehicle 10 will likely remain on the road 2500 (will not go off-road) the algorithm can predict upcoming road features the vehicle 10 will, such as the road elevation. Given the speed of the vehicle 10, the algorithm can also forecast at what time the road features will be encountered.

Continuing with this example, the algorithm determines that the vehicle 10 will reach position P2 and extracts from the road database the elevation information, which is elevation B. On the basis of the upcoming elevation information and the current elevation information, the algorithm determines the differential elevation. By taking into account the horizontal distance D between P1 and P2, which is also derived from the road database, the algorithm computes the inclination of the road to the horizontal or its grade.

Referring back to FIG. 11, the algorithm computes at step 1104 the magnitude of regenerative braking to be implemented when the propulsion demand ceases. Typically, the regenerative braking is reduced when the vehicle 10 climbs a grade, the degree of reduction being function of the grade; the higher the grade the higher the reduction. For example the reduction can be proportional to the grade.

Referring again to FIG. 25, the process repeats constantly as the vehicle 10 travels. As the vehicle 10 reaches the position P2 the algorithm determines that the grade further increases which results in a further reduction of the regenerative braking. At position P3, the algorithm determines that upcoming position P4 is at a lower elevation producing an increase of the regenerative braking.

Subsequent the computation of the regenerative braking the algorithm releases an output control signal at step 1106, to implement the regenerative braking effect.

In a possible variant, the differential elevation information can be derived locally without reference to an external infrastructure. For example the algorithm receives the acceleration signal and extracts from the signal the degree of inclination of the vehicle 10 with relation to a vertical axis. The inclination is indicative of the road grade. To avoid road irregularities from being interpreted as changes to the road grade, the inclination information can be averaged out before being used for making changes to the regenerative braking magnitude. For instance, the inclination information is collected for a period of time such as 10 seconds, averaged and then used to perform the regeneration braking computation. Alternatively, the algorithm can reject any inclination data which varies too much from a previously collected value and which likely is the result from a road irregularity over which the vehicle 10 travels.

### 5. Adaptive Regenerative Braking Based on Position Information

This process is illustrated by the flowchart at FIG. 26. The process starts at step 2600. At step 2602, the algorithm determines the position of the vehicle 10. This can be done as described earlier, by receiving a position signal from an external infrastructure. At step 2604, the algorithm extracts regenerative braking information from a database, such as the machine readable storage 42 on the basis of the position information. More specifically, the database maps position information with regenerative braking information. The regenerative braking information has been previously computed and loaded in the database by the manufacturer of the vehicle 10 or a third party.

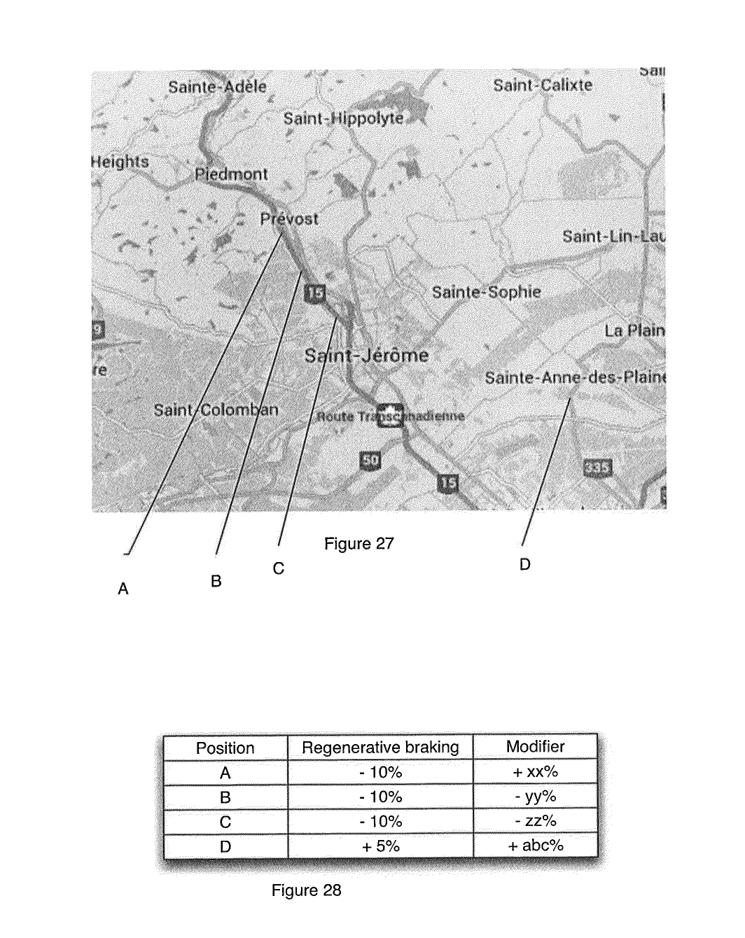

FIG. 27 illustrates how the database is conceptually structured. The database contains position information. The position information consists of an array of data points, each datapoint corresponding to a position of the vehicle on a given road. Consider the example of a vehicle traveling on highway number 15. That highway is represented in the database as a series of position coordinates. The number of position coordinates can vary depending on the desired degree of granularity. In the example, shown a segment of the highway is represented by three position coordinates, A, B and C. When the vehicle position matches position A, the control module 28 performs a look-up operation in the database to extract the regenerative braking magnitude corresponding to that position. FIG. 28 is an example, illustrating a list of position coordinates A, B, C and D and corresponding regenerative braking intensities expressed in term of increase or decrease with relation to a certain base line.

The specific regenerative braking magnitudes can be established depending on the desired control strategy. For example, in the case of a highway on which the vehicle is expected to travel at a relatively constant speed, which is typically the speed limit, with fewer instances of stopping by comparison to urban driving, the regenerative braking intensity can be reduced to allow the vehicle to coast better, thus preserving its momentum. This approach is better suited for an increased efficiency.

When the vehicle is at position D, which corresponds to a secondary road 335, the magnitude of the regenerative braking is increased because the nature of the road traveled is such that the vehicle is expected to stop more often, where an increased regenerative braking intensity is likely to produce a more efficient driving.

A different control strategy can be to increase safety. In such case, the regenerative braking on positions corresponding to major highways is increased, such as to bring the vehicle speed down more quickly when the driver lifts off the foot from the accelerator pedal.

With this arrangement, the system can adapt the regenerative braking intensity to the road type on which the vehicle is travelling. That adaptation can be biased toward increased efficiency or increased safety.

The database structure shown in FIG. 28 also includes a column labeled as ‘Modifier’ that allows to modify the regenerative braking intensity based on certain factors.

One such factor is road conditions, such as real time weather, real time traffic or road works. The road conditions are received from an external infrastructure by the controller module 28. That external infrastructure can be a cellular network with which the vehicle 10 communicates. If the weather information received shows that the road is slippery the modifier may be selected to increase the regenerative braking for increased safety. If the traffic information shows that there is heavy traffic or there are roadworks, which creates a situation where there is higher probability for the vehicle to stop, the regenerative braking intensity is increased, again for increased safety.

Current vehicle speed is another example of a modifier. The regenerative braking intensities determined on the basis of the vehicle position are adjusted depending on vehicle speed. Typically, with higher speed the regenerative braking intensity is increased for increased safety.

Referring back to FIG. 26, once the regenerative braking magnitude has been determined as described above at step 2604, a control signal is output at step 2606 such that the determined regenerative braking magnitude is applied.

### 6. Independent Regenerative Braking Control Between Front and Rear Wheels

This control algorithm is suitable for the vehicle architecture shown in FIG. 3, in which the front wheels and the rear wheels are driven by independent electric motor/generators 18, 18′.

Each electric motor/generator 18, 18′ can provide regenerative braking independently and it is thus independently controlled. In this fashion, the electric motor/generator 18 associated with the front wheels 12, 14 can provide a higher or lower degree of regenerative braking than the electric motor/generator 18′ associated with the rear wheels 12′, 14′. In addition to providing different levels of regenerative braking on the front and rear wheels, the regenerative braking acting on the front wheels and on the rear wheels can be triggered at different times.

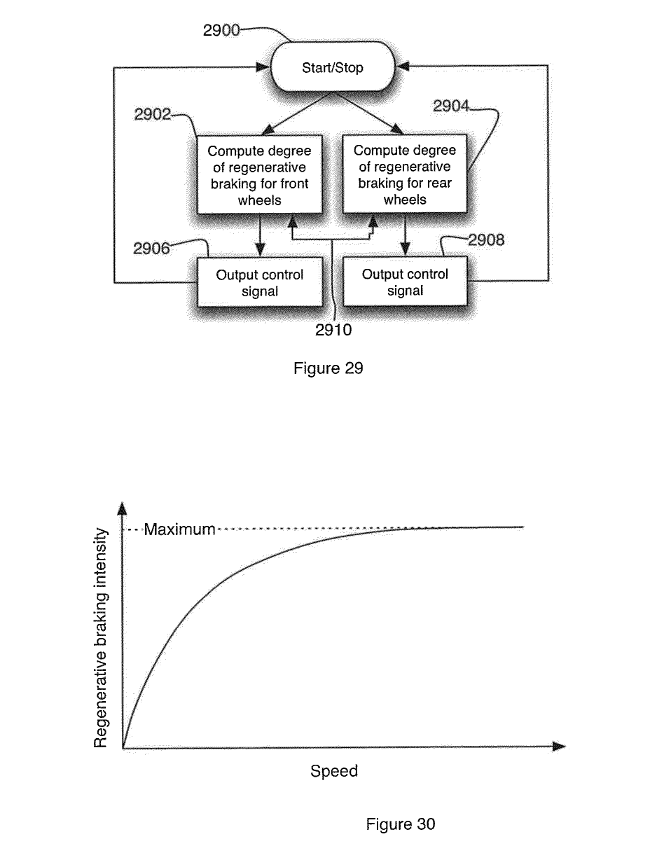

FIG. 29 provides an example of a process used for independently controlling the regenerative braking acting on the front wheels of the vehicle and on the rear wheels of the vehicle 10. The intent of FIG. 29 is to show that the software that manages the regenerative braking has essentially two processing paths that operate in parallel and that can control the regenerative braking independently. As the arrow 2910 shows the paths can interact, such that the regenerative braking on one axle is affected by what happens with the other axle.

The process at FIG. 29 starts at 29 and then branches out to two processing blocks 2902 and 2904 that compute the regenerative braking intensity for the front and for the rear wheels, respectively. Each processing block 2902 and 2904 lead to steps 2906 and 2908, respectively that output the control signal for electric motor/generators 18, 18′ to regulate the regenerative braking.

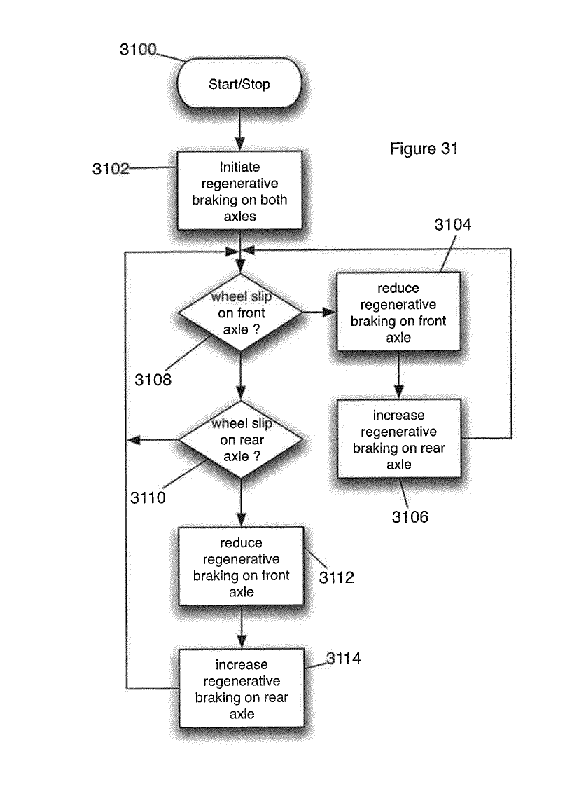

FIG. 31 is flowchart of a process that varies the regenerative braking on one axle when wheel slip is sensed on the other axle, such as to maintain the overall intended regenerative braking effect. Note that “axle” refers to a transverse pair of wheels and does not imply necessarily the presence of a common shaft to which the wheels are mounted.

The process starts at 3100. At step 3102, the controller module 28 initiates regenerative braking on both the front and the rear axles by the intermediary of electric motor/generators 18, 18′. The regenerative braking is triggered when the demand for propulsion ceases, such as when the driver releases the accelerator pedal. At step 3108 the system determines if wheel slip is created as a result of the regenerative braking on any one of the wheels of the front axle. If wheel slip is detected, one strategy is to discontinue or reduce the regenerative braking on that axle to prevent a loss of control of the vehicle. This is illustrated by step 3104. At the same time the regenerative braking acting on the rear axle is increased such as to maintain the overall feel of speed reduction the driver experiences. Note that sudden discontinuance of regenerative braking is not desired as it may create for some drivers the perception that the vehicle actually accelerates. Accordingly, maintaining the regenerative braking intensity before the wheel slip is event is beneficial.

The degree of increase of the regenerative braking provided by the rear axle can vary. One example is to increase it such as to fully compensate the loss of regenerative braking produced by the front axle. Another example is to provide an increase that provides a partial compensation.

An attempt at full compensation may not always be the best approach. When wheel slip on the front axle is due to a slippery road surface, a significant increase of the regenerative braking produced by the rear axle may cause the rear wheels to start slipping. In those circumstances, a partial increase may be a better approach.

Note that wheel slip is not always the result of a slippery road surface. If a front wheel travels over a vertical disturbance, such as a pot hole or railroad tracks protruding from the road surface, the suspension deflection may reduce the pressure of the tire on the road and the wheel may start slipping. Once the suspension settles, the nominal pressure the tire exerts on the road is resumed and the wheel stops slipping. However, the controller module 28 may take some time to detect that wheel slip no longer exists such that the regenerative braking produced by the front axle is not resumed immediately when the wheel stops slipping. Accordingly, even though the actual wheel slip is a momentary event, the period during which the regenerative braking produced by the front axle is much longer, and it can be in the order of one second or even more. From a driver perspective, such time period is undesirably long, because the discontinuance of the regenerative braking produced by the front axle is perceived as abnormal behavior of the vehicle.

In this scenario an increase of the regenerative braking produced by the rear axle to fully compensate the regenerative braking at the front axle is a desirable approach because the driver will see little or no change in the way the vehicle behaves. While there is some degree of risk that the vertical disturbance over which the rear wheel(s) are also likely to travel produce a wheel slip at the rear axle, this is not necessarily so, thus allowing a more aggressive compensation.

Steps 3110, 3112 and 3114 are similar to steps 3108, 3104 and 3106, with the exception they are performed in connection with the rear axle. Note that for wheel slip one either one of the rear wheels resulting from the rear suspension compressing as a result of a vertical disturbance, an aggressive compensation is less likely to create wheel slip on the front axle because the front wheels have already passed the vertical disturbance.

While not shown in the flow chart of FIG. 31, it is understood that once the wheel that is slipping is no longer slipping, the compensation produced by increasing the regenerative braking by the other axle is reduced while the regenerative braking on the axle associated with the slipping wheel is being increased. At that point, the compensation stops and the system resumes its operation before the wheel slip.

The process described in connection with FIG. 31 is performed before the driver depresses the brake pedal. However, the same process can also be performed when the brake pedal is depressed but before the friction brakes engage.

In a possible variant, no regenerative braking compensation is performed when wheel slip is detected, however the regenerative braking on the axle with wheels that are not slipping is maintained unchanged.

The independent regenerative braking between the front and the rear wheels can be used for stability control purposes. Prior art stability control systems use multiple sensors to determine if the automobile is maintaining stability control or loosing stability control. If a loss of stability control is sensed, the system will invoke the brakes and/or power reduction to help stabilize the vehicle.

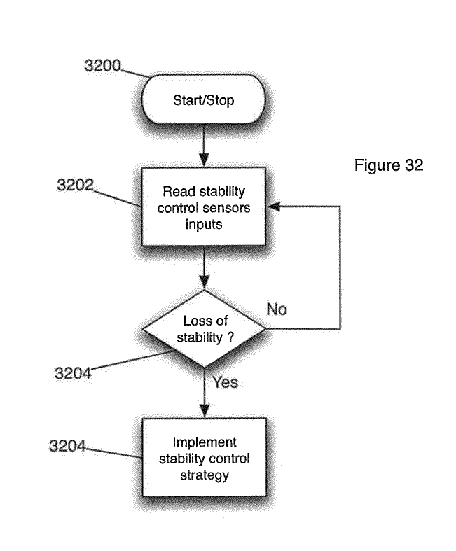

FIG. 32 is a flowchart of a process for performing stability control that uses regenerative braking.

At step 3202 the controller module 28 reads the output of the various sensors that are used to determine if the vehicle maintains stability control. Such sensors include the vehicle speed sensor that generates the vehicle speed signal, the steering angle sensor that generates the steering angle signal indicating how much steering input is being applied, the rotation rate signal generated by a yaw sensor. Note that the vehicle speed signal includes information about the speed of travel of the vehicle and also speed information on each wheel, which is used to determine if there is wheel slip.

Step 3204 processes the sensor inputs to determine if the vehicle is dynamically stable during a cornering maneuver, such as for example if the vehicle is stable in yaw. A vehicle that is not stable in yaw manifests a rotation rate that is inconsistent with the steering input. The existence of such inconsistency shows that the vehicle is oversteering or understeering.

If a yaw stability exists, the controller module 28 implements a stability control strategy to help compensate the oversteer or understeer. A number of different strategies are possible, including applying automatically the brakes at selected wheel to create a brake steering effect and stabilize the vehicle. At the same time the controller module 28 invokes regenerative braking, which is useful to enhance the selective braking application and also reduce the vehicle speed for an overall more effective stability control.

In a more specific example, when the controller module 28 detects a loss of yaw stability, a first step is to reduce or nullify the drive power applied by the electric motors/generators 18, 18. This reduction or nullification is done independently from the power demand which is indicated by the throttle position sensor. The reduction or nullification can be done symmetrically between the front and rear axles or asymmetrically. By symmetrically is meant that the same effect is applied at the front axle and at the rear axle. If a power reduction is commanded, it is the same on the front axle and on the rear axle. In an asymmetric control situation, the power control can be different between the front and the rear axles. For example, the power control can be reduced more on the front axle than on the rear and vice-versa. In another possible scenario, the power can be reduced on one axle but completely nullified on the other.

When the power is nullified on one axle or on both axles, regenerative braking can be invoked. The usefulness of the regenerative braking is to assist with deducting the vehicle speed and make the other stability control inputs more effective.

The regenerative braking can be invoked with different levels of intensity between the front and the rear axles, assuming that no drive power is applied on the axles.

While regenerative braking is being applied, the friction brakes can be applied to selective wheels of the vehicle to create brake steer and compensate for an understeer or oversteer. To compensate for oversteer or understeer, the lateral distribution of the friction braking is controlled. In other words, the friction brakes are applied on the right side of the vehicle or the left side, depending on the particular yaw instability to be controlled.

A given axle can thus experience friction braking on one wheel and regenerative braking on the other, friction braking on both wheels or only regenerative braking on both wheels.

Also note that friction braking and regenerative braking are additive since they are provided by different mechanisms.

With reference to FIG. 4, with illustrates a vehicle architecture in which the four wheels are driven by individual electric motors, hence can provide independent regenerative braking, the stability control stray can be modified to provide lateral regenerative braking distribution.

Such control strategy can invoke regenerative braking as an initial response to a loss of yaw stability and then follow up with a more aggressive selective braking application. In a specific example, when the stability control strategy determines that braking is required on the left of on the right side of the vehicle, regenerative braking is invoked as the magnitude required. For instance, on the front axle, regenerative braking is applied on one of the wheel and not on the other or applied at different levels; more on one wheel than on the other.

The same regenerative braking distribution can be made on the rear axle.

If after application of the regenerative braking no sufficient yaw instability compensation has occurred, the strategy then invokes the friction brakes as discussed earlier. The consecutive regenerative braking and friction braking allows a more measured and precise response to a detected yaw instability.

### 7. Regenerative Braking Based on Speed Limit Information

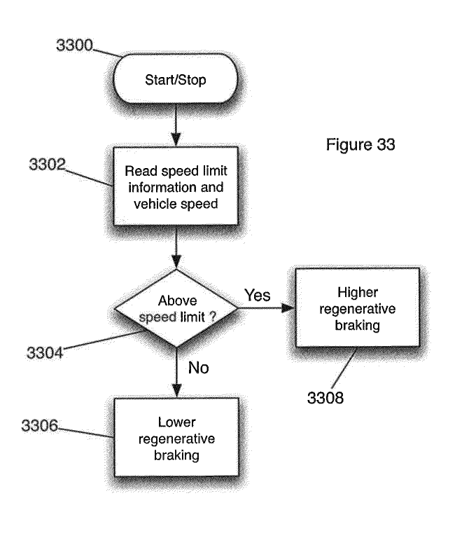

FIG. 33 is a flow chart of a process for managing the regenerative braking that takes into account the speed limit on the road on which the vehicle is traveling. The usefulness of this strategy is to allow the driver of the vehicle to help maintain a speed that does not exceed the limit or if it does, the vehicle will more aggressively slow down until the limit has been reached.

At step 3302 the controller module 28 reads the vehicle speed and also the speed limit in force on the read on which the vehicle is traveling. The speed limit information can be obtained from a source that is external the vehicle or can be internally generated from a database that maps vehicle position (such as from a GPS) to vehicle speed limit information.

The external source can be any source that can supply speed limit information. For example, the vehicle can communicate with the external source and send to the external source its current position and the external source returns in response to the position the speed limit information. This communication can occur at different rates depending on how often the speed limit information needs to be updated.

If the process at step 3302 determines that the vehicle travels above the speed limit, the level of regenerative braking applied is increased, as shown at step 3308. In such case, if the driver releases the accelerator pedal the regenerative braking intensity is higher than if the speed of the vehicle is at or below the speed limit. A more intense regenerative braking slows down the vehicle faster such that the vehicle's speed can be brought quicker at the speed limit.

Note that this process does not preclude the vehicle from traveling above the speed limit. However, if the driver chases, so, a speed limit dependent regenerative braking makes it easier and faster bring the vehicle to the speed limit.

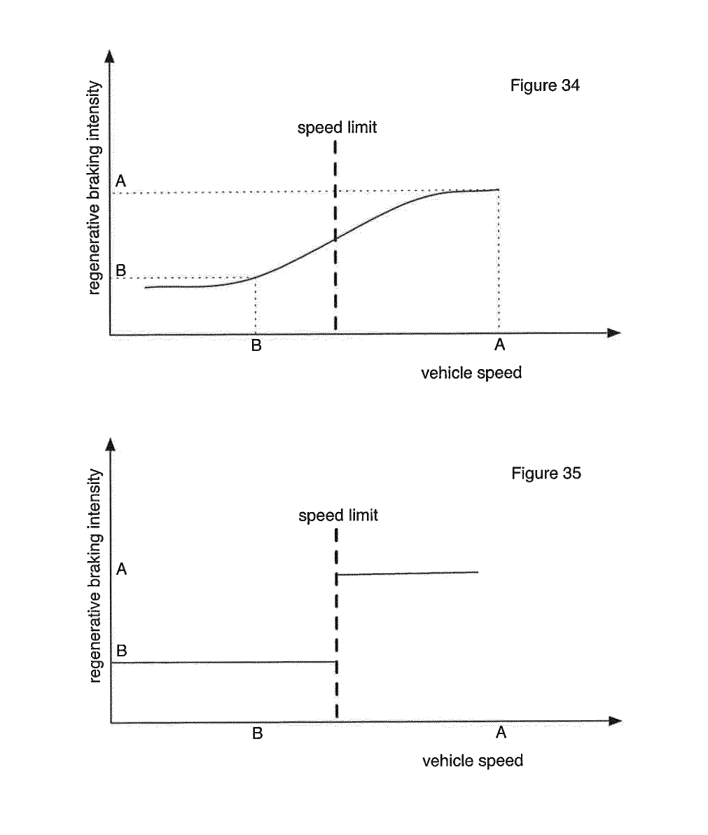

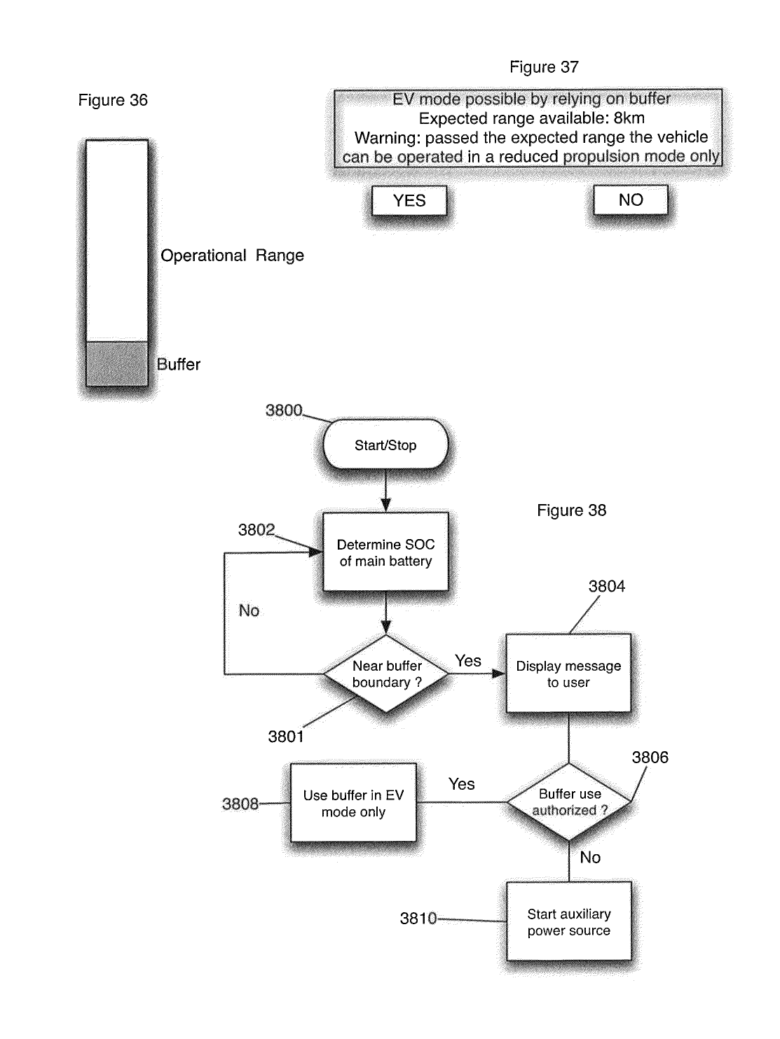

FIG. 34 is a graph showing the variation of the regenerative braking intensity based on speed. At operational point A, which corresponds to a vehicle speed that is above the speed limit, the magnitude of the regenerative braking is at a level A. As the vehicle slows down, the magnitude of the regenerative braking progressively diminishes until it reaches the speed limit. In this example, the speed limit coincides with an inflection point at which the magnitude of the regenerative braking starts stabilizing.

At operational point B, the magnitude of the regenerative braking is lower, meaning that the vehicle will coast more freely and its speed will diminish at a lower rate.

This control strategy results in a behavior during which the rate of speed reduction is higher if the vehicle travels above the speed limit. The transition at or around the speed limit can be progressive, as shown in FIG. 34 or it can be more pronounced if desired. FIG. 35 illustrates such a variant in which the transition is more abrupt and results in an immediate reduction in regenerative braking when the speed limit is reached. This variant has the added advantage of providing a speed stabilization effect, allowing the vehicle to coast at or near the speed limit.

### 8. Battery Buffer Regulation in an EREV (Extended Range Electric Vehicle) Vehicle

As briefly discussed earlier, an EREV vehicle has an electrical propulsion that draws power from a battery and also uses an auxiliary power source that is invoked when the battery is operationally depleted. The auxiliary power source typically generates electricity; when the battery is operationally depleted the electric flow comes from the auxiliary power source to drive the electric motor(s) of the vehicle. The auxiliary power source can be an internal combustion engine driving a generator. Alternatively, the auxiliary power source can be a fuel cell which is supplied with hydrogen to produce electricity.

For economy and fuel efficiency reasons, the auxiliary power source is dimensioned such that it is as small as possible. In most practical implementation of EREVs today the auxiliary power source cannot practically on its own propel the vehicle. It is important to understand that the power required to propel a vehicle varies greatly over its operational range; when the vehicle accelerates the power output required from the power train is several times the power output required to maintain a steady speed. Assuming the auxiliary power source is sized such that it can provide sufficient power output to maintain a steady speed and a moderate acceleration but not the power required for a maximal acceleration, the driver of the vehicle will see a noticeable performance degradation when the battery is depleted and the auxiliary power source invoked to propel the vehicle. In other words, the vehicle will not be able to accelerate as quickly as when operated in pure EV mode or may not even be able to maintain a steady speed when climbing a hill.

In a commercially available EREV, such as the Volt (trademark) that is commercialized by Chevrolet, the auxiliary power source is managed to avoid this performance degradation problem by reserving in the main battery a buffer which is used to supplement any power deficit of the auxiliary power source when it is being used to propel the vehicle. The auxiliary power source is thus invoked before the battery is fully depleted; the size of the buffer may be anywhere from 2% to 30% of the usable battery capacity. When the driver commands maximal power, the auxiliary power source supplies only a portion of the power demand and the balance is taken from the buffer. In this fashion, the vehicle performance does not change when the vehicle is in pure EV mode or in a Range Extended mode.

To avoid depleting the buffer, which will result in a reduced propulsion capability, the software managing the operation of the auxiliary power source operates the latter such as to replenish the buffer at the earliest possible opportunity, when the buffer has been used and it is at a state of charge less than the nominal amount. For example, after a hard acceleration followed by a drive at a steady speed, the auxiliary power source is operated at a power output higher than the steady speed would require, such that the excess can replenish the buffer.

It is known to provide the driver with a control allowing to adjust the buffer size for more extreme driving conditions during which the buffer is expected to be relied upon more than in a usual acceleration/steady drive pattern. An example of such instance is when climbing a high hill when the power demand to maintain a steady speed while climbing would exceed the maximal power output of the auxiliary power source. Essentially the driver can set the buffer at a higher level than usual when planing a drive involving a steep and extended climb.

In most driving scenarios, however, the buffer is inefficiently used. The managing software is programmed to start the auxiliary power source as soon as the state of charge of the battery drops to the buffer level. The managing software does not take into account the particular circumstances which may make it possible to continue operating the vehicle, in an EV mode only from the buffer, without the need to start the auxiliary power source.

For example, when the battery is depleted to the buffer level, but the vehicle is at a short distance from destination, the present invention allows to continue operating the vehicle from the buffer, which is sufficient to bring the vehicle to destination, where it can be recharged. In this fashion, the vehicle is operated in EV mode only, without the need to start the auxiliary power source.

The invention is a process and system to control the buffer on the basis of a control signal which conveys information that is particular to the vehicle or the immediate driving circumstances such as to allow operating the vehicle longer in a pure EV mode, than would otherwise be possible.

The control signal can be generated via interaction with the driver or as a result of processing inputs that convey information about the driving environment.

The interaction with the vehicle involves changing a modifiable setting such that the vehicle can use the electrical energy stored in the buffer that is normally reserved for the operation of the auxiliary power source, such that the vehicle can continue operating in EV mode only and the auxiliary power source is not relied upon for propulsion.

One example is to show on the driver display screen a message asking whether the driver authorizes that the buffer be used for EV operation only. FIG. 37 shows an example of this message. Since the decision that the driver must make is likely based on the particular circumstances of the trip, such as the total remaining distance to destination, or the type of driving that is expected, the message displays the expected additional EV range that the vehicle will can provide. In the example shown, the message says that 8 additional kilometers will be available, although this is a very specific example. The range allowed by the buffer is determined on the basis of the size of the buffer and the rate of electrical consumption to propel the vehicle, which depend on the particular driving circumstances, whether urban driving or highway driving (which requires more energy per unit of time due to the added wind resistance), the outside temperature, which determines cabin heating requirements, among others.

The driver has the option of authorizing the use of the buffer by actuating the appropriate GUI control, the “YES” control in the circumstances. Alternatively, the driver may decline, if he/she expects a longer drive to destination than the buffer can provide and during which the full propulsion power is desirable.

The flow chart at FIG. 38 describes the process in more detail. The process, which is performed by the controller module 28 starts at step 3800. At step 3801, the controller module 28 reads the State of Charge (SOC) of the battery. If the SOC is near the lower end of the operational range of the battery, where normally the controller module 28 would start the auxiliary power source, the controller module 28 displays, at step 3804 the message shown at FIG. 37, which includes an estimation of the available EV range based on the buffer.

At query step 3806 the controller module 28 determines if the driver has authorized use of the buffer for EV mode of operation only. In the affirmative, as shown at step 3808 the vehicle continues operating in EV mode only, until the buffer is depleted at which point the auxiliary power source is started. In the instance the driver has not authorized the use of the buffer, then the auxiliary power source is started, as shown at step 3810.

Instead of relying on the driver to determine if the buffer can be used for EV mode of operation only, the software executed by the controller module can be provided with logic that can make an automatic determination.

One possibility is to use destination information, which tells the controller 28 the destination of the vehicle, and which is essentially the end point of the trip, beyond which the vehicle does not need to go. If the buffer can provide sufficient range to reach that end point, then it may not be necessary to start the auxiliary power source. This logic, assumes to some extent that charging capability will be available at the destination, where the main battery and the buffer can be recharged.

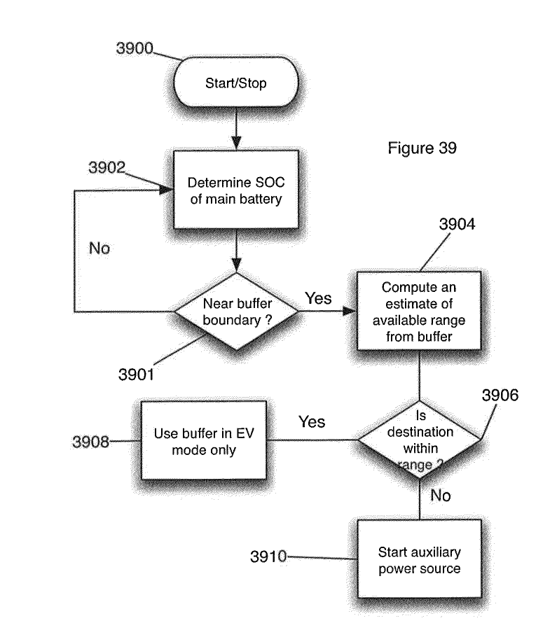

The destination information can be generated from a GPS based navigation system. For instance, the destination information can be entered by the driver, as an address for example. The flowchart at FIG. 39, illustrates the process.

The process starts at 3900. At 3902 the controller module determines the state of charge of the battery. If at step 3901, the operational range is determined to be exhausted, in other words, the battery is depleted and only the buffer remains, step 3904 computes an estimate of the available range that will be available with the buffer alone. At step 3906, that estimate is compared to the distance to destination. If the destination is within range, the controller module 28 continues operating the vehicle in EV mode only, as shown at step 3908. Otherwise, the auxiliary power source is started at 3910. Optionally, a message may be displayed to the driver to inform the driver that the buffer is being relied upon for EV mode and also provide the driver the option to override this mode of operation, buy operating a control, such as a button. If the control is operated the process branches to step 3910 where the auxiliary power source is started.

Referring back to decision step 3906, if the query determines that the destination is not within range, then the auxiliary power source is started at step 3910.

Note that in the drawings and description above, the buffer is shown as a part of the main battery, but this is not absolutely necessary. The buffer may be an energy storage device that is separate from the main battery.

1. (canceled)

2. A vehicle having a plurality of wheels, the vehicle comprising:
(a) a battery for storing electrical energy;
(b) an electric motor arrangement in a driving relationship with one or more wheels of the vehicle, the battery supplying electrical energy to the electric motor arrangement to drive the one or more wheels;
(c) a braking arrangement, including:
(i) a friction braking system operated by a brake pedal;
(ii) a regenerative braking system;
(iii) a control system to adjust an intensity of the regenerative braking system, the control system including:
(1) a machine readable storage encoded with non-transitory software for execution by a CPU;
(2) an output, the software being configured for processing an input signal derived from usage of the friction braking system occurring prior to discontinuance of a demand for propulsion effort by the electric motor arrangement to determine a braking intensity of the regenerative braking system to be implemented after the discontinuance of the demand for propulsion effort;
(3) an output for outputting an output signal indicative of the determined braking intensity;
(iv) the regenerative braking system being responsive to the output signal to implement regenerative braking according to the determined intensity.
